(19) United States
(12) Patent Application Publication
(10) Pub. No.: US 2007/0237140 A1
(43) Pub. Date: Oct. 11, 2007

(54) Packet Communication System

(75) Inventors: Yukimasa Sugino, Tokyo (JP); Shigeaki Suzuki, Tokyo (JP); Wataru Fushimi, Tokyo (JP); Isamu Ogawa, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 11/587,587

(22) PCT Filed: Apr. 27, 2004
(86) PCT No.: PCT/JP04/06081

§ 371 Date: Oct. 26, 2006

(51) Int. Cl. H04L 12/56

(52) U.S. Cl. 370/389

(57) ABSTRACT

A packet communication system includes a communication control apparatus 8 for searching for an IP address corresponding to a destination telephone number when receiving a connection request including the destination telephone number from a VoIP terminal, and a multiplexing control apparatus 9 for identifying both a multiplexing transmission apparatus 11 or 10 which manages a VoIP terminal associated with the address searched for by the communication control apparatus 8, and a multiplexing transmission apparatus 10 or 11 which manages the VoIP terminal which is the transmission source of the connection request, and for notifying each of both the identified multiplexing transmission apparatus 10 and 11 of the address of the multiplexing transmission apparatus 11 or 10 on the other end of connection and the address of the VoIP terminal.

### FIELD OF THE INVENTION

The present invention relates to a packet communication system which packetizes a signal including a sound signal into packets and transmits them.

### BACKGROUND OF THE INVENTION

A VoIP (Voice over IP) technology for IP-packetizing and transmitting a telephone voice signal or a facsimile signal has received attention as developments have been produced in IP (Internet Protocol) communications in recent years.

However, in a case in which a VoIP terminal transmits IP packets directly to another VoIP terminal, it is known that the overhead of IP packets increases.

Therefore, in order to reduce the overhead of IP packets without causing any increase in the transmission delay in voice, a gateway and a multiplexing transmission apparatus are disposed in a prior art packet communication system.

Concretely, a gateway and a multiplexing transmission apparatus are disposed as follows. In an example as mentioned below, a combination of a telephone and a gateway corresponds to a VoIP terminal.

First, when a telephone digitizes an analog voice signal into digital voice data and sends out it, a gateway receives the voice data sent out from the telephone via a public switched telephone network.

When receiving the voice data from the telephone, the gateway IP-packetize the voice data and outputs them to a multiplexing transmission apparatus.

A plurality of short packets (a sequence number and a destination PSTN address (PSTN: Public Switched Telephone Network), a destination gateway address, a destination multiplexing transmission apparatus address, and voice data) are multiplexed into the payload of each IP packet.

When receiving two or more IP packets from two or more gateways, each multiplexing transmission apparatus extracts short packets from the two or more IP packets, collects short packets which are transmitted to an identical destination multiplexing transmission apparatus, multiplexes and IP-packetizes these short packets again into an IP packet, and transmits them to the destination multiplexing transmission apparatus.

When receiving the IP packet, the destination multiplexing transmission apparatus extracts voice data from the IP packet and transmits the voice data to the destination telephone (refer to patent reference 1).

“Patent reference 1” JP,2000-4259,A (refer to paragraph numbers [0011] to [0042] and FIG. 1)

Since prior art packet communication systems are so constructed as mentioned above, each telephone connected to the network needs to prestore the telephone numbers and IP addresses of all other telephones which exist in the network, and the IP address of a multiplexing transmission apparatus associated with each telephone. However, because telephones are equipment which end users own, a huge number of telephones are connected to the network. Furthermore, because telephones are equipment which end users own, additional telephones are installed frequently in the network and telephones are removed frequently from the network. A problem is therefore that it is actually difficult for each telephone to prestore the IP addresses and so on of all other telephones which exist in the network.

The present invention is made in order to solve the above-mentioned problem, and it is therefore an object of the present invention to provide a packet communication system which can reduce the overhead of IP packets without causing any increase in the transmission delay in voice even when many VoIP terminals are connected to the network.

### DISCLOSURE OF THE INVENTION

In accordance with the present invention, there is provided a multiplexing transmission apparatus including a communication control apparatus for, when receiving a connection request including a destination telephone number from a terminal device, searching for an address corresponding to the destination telephone number, and a multiplexing control apparatus for identifying both a multiplexing transmission apparatus which manages a terminal device associated with the address searched for by the communication control apparatus, and a multiplexing transmission apparatus which manages the terminal device which is the transmission source of the connection request, and for notifying each of both the identified multiplexing transmission apparatus of an address of the multiplexing transmission apparatus on another end of connection and the address of the terminal device.

Therefore, the present invention offers an advantage of being able to reduce the overhead of IP packets without increase in the transmission delay of voice packets even when many VoIP terminals are connected to the network.

### BRIEF DESCRIPTION OF THE FIGURES

FIG. 1 is a block diagram showing a packet communication system in accordance with embodiment 1 of the present invention;

FIG. 2 is an explanatory diagram showing the format of packets multiplexed by the multiplexing transmission apparatus;

FIG. 3 is a block diagram showing a packet communication system in accordance with embodiment 2 of the present invention;

FIG. 4 is a block diagram showing a packet communication system in accordance with embodiment 3 of the present invention;

FIG. 5 is a block diagram showing a packet communication system in accordance with embodiment 4 of the present invention;

FIG. 6 is an explanatory diagram showing the format of packets multiplexed by the multiplexing transmission apparatus;

FIG. 7 is a schematic block diagram showing a packet communication system in a case of carrying out communication control according to an SIP protocol;

FIG. 8 is a sequence diagram showing a communications protocol of the packet communication system;

FIG. 9 is a sequence diagram showing a communications protocol of a packet communication system in accordance with embodiment 6 of the present invention;

FIG. 10 is a sequence diagram showing a communications protocol of a packet communication system in accordance with embodiment 7 of the present invention;

FIG. 11 is a sequence diagram showing a communications protocol of a packet communication system in accordance with embodiment 8 of the present invention;

FIG. 12 is a block diagram showing a packet communication system in accordance with embodiment 9 of the present invention;

FIG. 13 is a block diagram showing a packet communication system in accordance with embodiment 10 of the present invention;

FIG. 14 is a sequence diagram showing a communications protocol of a packet communication system in accordance with embodiment 10 of the present invention;

FIG. 15 is a sequence diagram showing a communications protocol of a packet communication system in accordance with embodiment 10 of the present invention;

FIG. 16 is a sequence diagram showing a communications protocol of a packet communication system in accordance with embodiment 11 of the present invention;

FIG. 17 is a sequence diagram showing a communications protocol of a packet communication system in accordance with embodiment 12 of the present invention; and

FIG. 18 is a sequence diagram showing a communications protocol of a packet communication system in accordance with embodiment 13 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

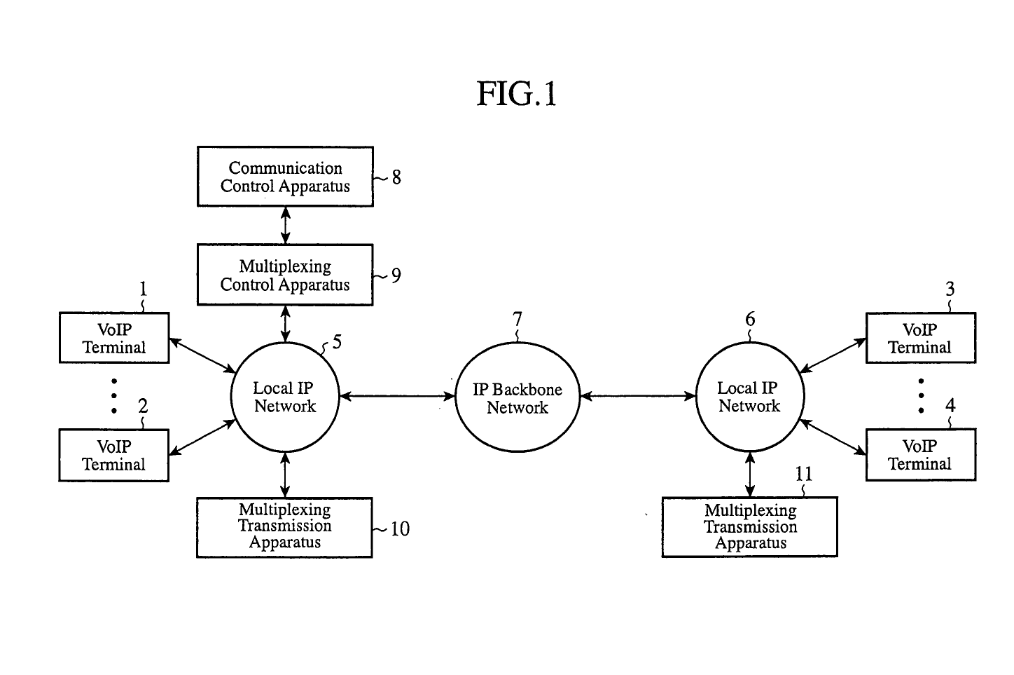

FIG. 1 is a block diagram showing a packet communication system in accordance with embodiment 1 of the present invention. In the figure, each of VoIP terminals 1 to 4 is a terminal device, such as a telephone or a facsimile, the VoIP terminals 1 and 2 are connected to a local IP network 5, and the VoIP terminals 3 and 4 are connected to a local IP network 6. The local IP networks 5 and 6 are connected to an IP backbone network 7.

When receiving a connection request including a destination telephone number (for example, the telephone number of the VoIP terminal 4) from, for example, the VoIP terminal 1, a communication control apparatus 8 searches for an IP address corresponding to the destination telephone number, and then outputs the searched result to a multiplexing control apparatus 9. The multiplexing control apparatus 9 identifies both a multiplexing transmission apparatus 11 which manages the VoIP terminal 4 associated with the IP address searched for by the communication control apparatus 8, and a multiplexing transmission apparatus 10 which manages the VoIP terminal 1 which is the transmission source of the connection request, and notifies both the IP address of the multiplexing transmission apparatus 10 and the IP address of the VoIP terminal 1 to the multiplexing transmission apparatus 11 while notifying the IP address of the multiplexing transmission apparatus 11 and the IP address of the VoIP terminal 4 to the multiplexing transmission apparatus 10.

When receiving two or more IP packets from the VoIP terminals 1 and 2, the multiplexing transmission apparatus 10 multiplexes and transmits them to the multiplexing transmission apparatus 11. In contrast, when receiving multiplexed IP packets from the multiplexing transmission apparatus 11, the multiplexing transmission apparatus 10 demultiplexes the multiplexed IP packets into two sets of IP packets, and transmits them to the VoIP terminals 1 and 2, respectively. When receiving two or more IP packets from the VoIP terminals 3 and 4, the multiplexing transmission apparatus 11 multiplexes and transmits them to the multiplexing transmission apparatus 10. In contrast, when receiving multiplexed IP packets from the multiplexing transmission apparatus 10, the multiplexing transmission apparatus 11 demultiplexes the multiplexed IP packets into two sets of IP packets, and transmits them to the VoIP terminals 3 and 4, respectively.

Next, the operation of the packet communication system in accordance with this embodiment of the present invention will be explained.

For example, when the user of the VoIP terminal 1 dials the telephone number of the VoIP terminal 4, the VoIP terminal 1 transmits a connection request packet (i.e., a control packet) including the destination telephone number (i.e., the telephone number of the VoIP terminal 4) to the multiplexing control apparatus 9.

When receiving the connection request packet including the destination telephone number (i.e., the telephone number of the VoIP terminal 4) from the VoIP terminal 1, the multiplexing control apparatus 9 transmits the connection request packet to the communication control apparatus 8, and also stores the connection request packet therein temporarily.

When receiving the connection request packet including the destination telephone number (i.e., the telephone number of the VoIP terminal 4) from the multiplexing control apparatus 9, the communication control apparatus 8 searches for the IP address corresponding to the telephone number of the VoIP terminal 4, and then sends the searched result to the multiplexing control apparatus 9.

The communication control apparatus 8 manages the telephone numbers and IP addresses of the VoIP terminals 1 to 4 which are connected to the local IP networks 5 and 6, respectively.

When receiving the IP address searched for by the communication control apparatus 8, the multiplexing control apparatus 9 refers to the IP address so as to identify the multiplexing transmission apparatus 11 which manages the VoIP terminal 4 which is the destination, and to further identify the multiplexing transmission apparatus 10 which manages the VoIP terminal 1 which is the transmission source of the connection request packet.

The multiplexing control apparatus 9 then incorporates the IP address of the multiplexing transmission apparatus 11 which manages the VoIP terminal 4 into the connection request packet which it has received from the VoIP terminal 1 (i.e., replaces the IP address of the VoIP terminal 1 which is originally included in the connection request packet with the IP address of the multiplexing transmission apparatus 11), and transmits the connection request packet to the VoIP terminal 4.

When receiving the connection request packet from the multiplexing control apparatus 9, the VoIP terminal 4 transmits a connection grant packet (i.e., a control packet) to the multiplexing control apparatus 9 if the VoIP terminal 4 is placed in a state in which it can be connected with another VoIP terminal (for example, in a state in which it is not communicating with any other VoIP terminal).

When receiving the connection grant packet from the VoIP terminal 4, the multiplexing control apparatus 9 then transmits the connection grant packet to the communication control apparatus 8.

The multiplexing control apparatus 9 then incorporates the IP address of the multiplexing transmission apparatus 10 which manages the VoIP terminal 1 which is the transmission source of the connection request into the connection grant packet which it has received from the VoIP terminal 4 (i.e., replaces the IP address of the VoIP terminal 4 which is originally included in the connection grant packet with the IP address of the multiplexing transmission apparatus 10), and transmits the connection grant packet to the VoIP terminal 1.

When transmitting the connection grant packet to the VoIP terminal 1 in the above-mentioned way, the multiplexing control apparatus 9 transmits pieces of multiplexing information to the multiplexing transmission apparatus 10 and 11, respectively.

In other words, the multiplexing control apparatus 9 notifies, as the multiplexing information, the IP address of the VoIP terminal 1 which is the transmission source of IP packets, the IP address of the multiplexing transmission apparatus 11 which is the transmission destination of multiplexed packets, and the IP address of the VoIP terminal 4 which is the final destination to the multiplexing transmission apparatus 10.

The multiplexing control apparatus 9 also notifies, as the multiplexing information, the IP address of the VoIP terminal 4 which is the transmission source of IP packets, the IP address of the multiplexing transmission apparatus 10 which is the transmission destination of multiplexed packets, and the IP address of the VoIP terminal 1 which is the final destination to the multiplexing transmission apparatus 11.

When receiving the connection grant packet including the IP address of the multiplexing transmission apparatus 10 from the multiplexing control apparatus 9, the VoIP terminal 1 recognizes an establishment of communications, and also recognizes that the transmission destination of the voice packets is the multiplexing transmission apparatus 10 and, after that, transmits the voice packets to the multiplexing transmission apparatus 10.

When receiving the voice packets from the VoIP terminal 1, the multiplexing transmission apparatus 10 multiplexes the voice packets. In this case, when also receiving voice packets from another VoIP terminal other than the VoIP terminal 1 (e.g., the VoIP terminal 2), the multiplexing transmission apparatus 10 extracts short packets from the plurality of voice packets, collects short packets which are destined for an identical multiplexing transmission apparatus from the extracted short packets, and multiplexes and IP-packetizes the collected short packets again.

In the example of FIG. 1, because only the multiplexing transmission apparatus 11 exists in the system in addition to the multiplexing transmission apparatus 10, multiplexing transmission apparatus which are the destinations of the short packets extracted from the plurality of voice packets are only the multiplexing transmission apparatus 11. If two or more multiplexing transmission apparatus exist in the system in addition to the multiplexing transmission apparatus 10, short packets which are destined for each of the two or more identical multiplexing transmission apparatus other than the multiplexing transmission apparatus 10 are collected from the extracted short packets and multiplexed again.

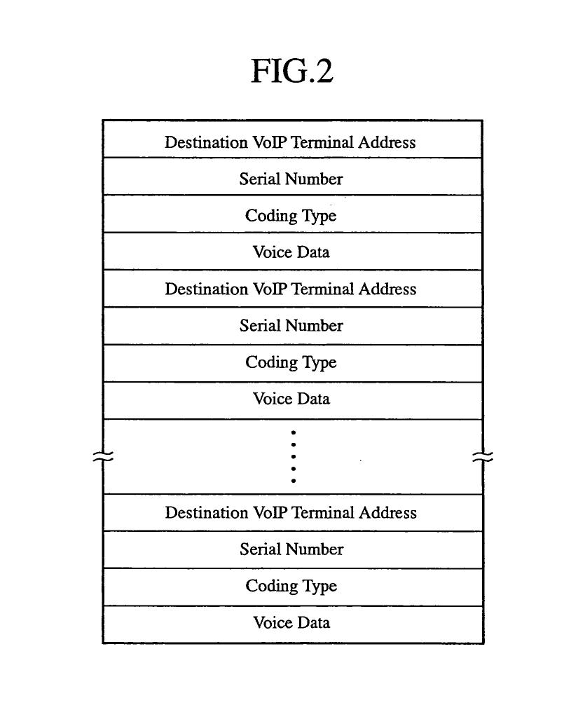

FIG. 2 shows the format of a packet into which short packets are multiplexed by the multiplexing transmission apparatus 10. A destination VoIP terminal address, a serial number, and a coding type are attached to the header of each of the short packets which constitute the packet. The destination VoIP terminal address is the IP address of the VoIP terminal 4 which is the final destination, the serial number is a numeric value which is given to each short packet which is destined for an identical destination, and which increases by 1 every time when it has been given to each short packet, and is used for detection of a loss of the corresponding short packet, and the coding type is coded information indicating the type of a coding method of coding the voice data.

The multiplexing transmission apparatus 10 then refers to the multiplexing information transmitted from the multiplexing control apparatus 9, recognizes the IP address of the multiplexing transmission apparatus 11 which is the transmission destination of the multiplexed packets, and transmits the multiplexed packets to the multiplexing transmission apparatus 11.

When receiving the multiplexed packets from the multiplexing transmission apparatus 10, the multiplexing transmission apparatus 11 demultiplexes the multiplexed packets to extract the voice packets, refers to the multiplexing information transmitted from the multiplexing control apparatus 9, and recognizes the IP address of the VoIP terminal 4 which is the final destination of the voice packets.

The multiplexing transmission apparatus 11 then transmits the voice packets to the VoIP terminal 4 which is the final destination.

After transmitting the connection grant packet to the multiplexing control apparatus 9, the VoIP terminal 4 recognizes that the transmission destination of the voice packets is the multiplexing transmission apparatus 11, and, after that, transmits the voice packets to the multiplexing transmission apparatus 11.

When receiving the voice packets from the VoIP terminal 4, the multiplexing transmission apparatus 11 multiplexes the voice packets. In this case, when also receiving voice packets from another VoIP terminal other than the VoIP terminal 4 (e.g., the VoIP terminal 3), the multiplexing transmission apparatus 11 extracts short packets from the plurality of voice packets, collects short packets which are destined for an identical multiplexing transmission apparatus from the extracted short packets, and multiplexes and IP-packetizes the collected short packets again.

In the example of FIG. 1, because only the multiplexing transmission apparatus 10 exists in the system in addition to the multiplexing transmission apparatus 11, multiplexing transmission apparatus which are the destinations of the short packets extracted from the plurality of voice packets are only the multiplexing transmission apparatus 10. If two or more multiplexing transmission apparatus exist in the system in addition to the multiplexing transmission apparatus 11, short packets which are destined for each of the two or more identical multiplexing transmission apparatus other than the multiplexing transmission apparatus 11 are collected from the extracted short packets and multiplexed again.

The multiplexing transmission apparatus 11 then refers to the multiplexing information transmitted from the multiplexing control apparatus 9, recognizes the IP address of the multiplexing transmission apparatus 10 which is the transmission destination of the multiplexed packets, and transmits the multiplexed packets to the multiplexing transmission apparatus 10.

When receiving the multiplexed packets from the multiplexing transmission apparatus 11, the multiplexing transmission apparatus 10 demultiplexes the multiplexed packets to extract the voice packets, refers to the multiplexing information transmitted from the multiplexing control apparatus 9, and recognizes the IP address of the VoIP terminal 1 which is the final destination of the voice packets.

The multiplexing transmission apparatus 10 then transmits the voice packets to the VoIP terminal 1 which is the final destination.

Although the packet communications between the VoIP terminal 1 and the VoIP terminal 4 are thus established, the multiplexing control apparatus 9 needs to recognize a correspondence between the VoIP terminals 1 to 4 and the multiplexing transmission apparatus 10 and 11 in advance in order that such packet communications are established between VoIP terminals. For this reason, when the multiplexing transmission apparatus 10 and 11 are installed on the network, the IP addresses of the VoIP terminals 1 to 4 and the IP addresses of the multiplexing transmission apparatus 10 and 11 are set up for the multiplexing control apparatus 9.

It is not impossible to set up a correspondence between the IP addresses of all the VoIP terminals 1 to 4 and the IP addresses of the multiplexing transmission apparatus 10 and 11 each of which can be a connection destination. In accordance with this embodiment 1, a correspondence between the IP addresses of all the VoIP terminals 1 to 4 and the IP addresses of the multiplexing transmission apparatus 10 and 11 is set up using the following method.

For example, the IP addresses of the VoIP terminals 1 and 2 connected to the local IP network 5 are set up so that they fall within a range of from “a.b.c.0” to “a.b.c.255”, and the IP addresses of the VoIP terminals 3 and 4 connected to the local IP network 6 are set up so that they fall within a range of from “d.e.f.0” to “d.e.f.255.” Each of the set of a, b, and c, and the set of d, e, and f identifies three highmost bytes of the IP address, and the lowermost byte of the IP address shows an integer falling within a range of from “0” to “255.”

In the case in which the IP addresses of the VoIP terminals 1 to 4 are thus set up, it can be determined promptly that the VoIP terminals 1 and 2 whose IP addresses fall within the range of from “a.b.c.0” to “a.b.c.255” correspond to the multiplexing transmission apparatus 10, and the VoIP terminals 3 and 4 whose IP addresses fall within the range of from “d.e.f.0” to “d.e.f.255” correspond to the multiplexing transmission apparatus 11.

In this case, the multiplexing control apparatus 9 can easily search for the corresponding multiplexing transmission apparatus 10 and 11 from the IP addresses of the VoIP terminals 1 to 4.

In this embodiment 1, the case in which the VoIP terminals 1 and 4 transmit and receive packets to and from each other is explained as an example. In contrast, in a case in which VoIP terminals which are managed by the same multiplexing transmission apparatus 10 transmit and receive packets to and from each other, for example, in a case in which the VoIP terminals 1 and 2 transmit and receive packets to and from each other, the multiplexing control apparatus 9 does not transmit multiplexing information about the multiplexing transmission apparatus 10 and 11. In such a case, the VoIP terminals 1 and 2 are made to communicate voice packets directly to each other, not by way of the multiplexing transmission apparatus 10 and 11.

As can be seen from the above description, the packet communication system in accordance with this embodiment 1 includes the communication control apparatus 8 for searching for an IP address corresponding to a destination telephone number when receiving a connection request including the destination telephone number from a VoIP terminal, and the multiplexing control apparatus 9 for identifying both a multiplexing transmission apparatus 11 or 10 which manages a VoIP terminal associated with the address searched for by the communication control apparatus 8, and a multiplexing transmission apparatus 10 or 11 which manages the VoIP terminal which is the transmission source of the connection request, and for notifying each of both the identified multiplexing transmission apparatus 10 and 11 of the address of the multiplexing transmission apparatus 11 or 10 on the other end of connection and the address of the VoIP terminal. Therefore, the present embodiment offers an advantage of being able to reduce the overhead of IP packets without increase in the transmission delay of voice packets even when many VoIP terminals are connected to the network.

In other words, since each of the VoIP terminals 1 to 4 does not need to store the IP addresses of other VoIP terminals connected to the network, it can carry out packet multiplex transmission via the multiplexing transmission apparatus 11 or 10 even when many VoIP terminals are connected to the network. Therefore, the overhead of IP packets can be reduced without increase in the transmission delay of voice packets.

When multiplexing two or more packets, the packet communication system in accordance with this embodiment 1 forms a payload in the multiplexed packets from a plurality of short packets, and incorporates the address of a destination terminal device, a serial number, and identification information indicating a voice coding method into the header of each of the plurality of short packets. Therefore, the present embodiment offers another advantage of being able to apply an existing VoIP signaling protocol to the system.

The connection type of voice call passes and the format of messages exchanged between a VoIP terminal and the communication control apparatus 8 use a communication control method called VoIP signaling, and the communication control method is standardized by IETF (Internet Engineering Task Force) which is a standardization organization concerned with the Internet. As examples of the standardization, there are SIP (Session Initiate Protocol) which defines all communication control operations concerned with VoIP, and MEGACO (MEdia GAteway COntrol protocol) which is a protocol according to which the communication control apparatus 8 controls VoIP terminals and gateways. Therefore, such a protocol as SIP or MEGACO can be applied to the system.

According to this embodiment 1, in a case in which the multiplexing transmission apparatus which manages the VoIP terminal associated with the IP address searched for by the communication control apparatus 8 is the multiplexing transmission apparatus which manages the VoIP terminal which is the transmission source of a connection request, the multiplexing control apparatus makes the VoIP terminals which are targets for communications communicate packets directly to each other without notifying any IP address to the multiplexing transmission apparatus. Therefore, the present embodiment offers a further advantage of being able to improve the efficiency of packet communications between any two VoIP terminals connected to an identical local IP network.

According to this embodiment 1, when a multiplexing transmission apparatus is connected to the network, the packet communication system sets up the IP address of the multiplexing transmission apparatus, and IP addresses of VoIP terminals which the multiplexing transmission apparatus manages for the multiplexing control apparatus 9. Therefore, the present embodiment offers another advantage of being able to establish packet communications between any two of all VoIP terminals connected to the network.

According to this embodiment 1, the multiplexing control apparatus provides commonality of a highmost portion of the address of each multiplexing transmission apparatus, and highmost portions of the addresses of corresponding VoIP terminals. Therefore, the present embodiment offers a further advantage of being able to easily search for a corresponding multiplexing transmission apparatus from the IP address of a VoIP terminal.

### Embodiment 2

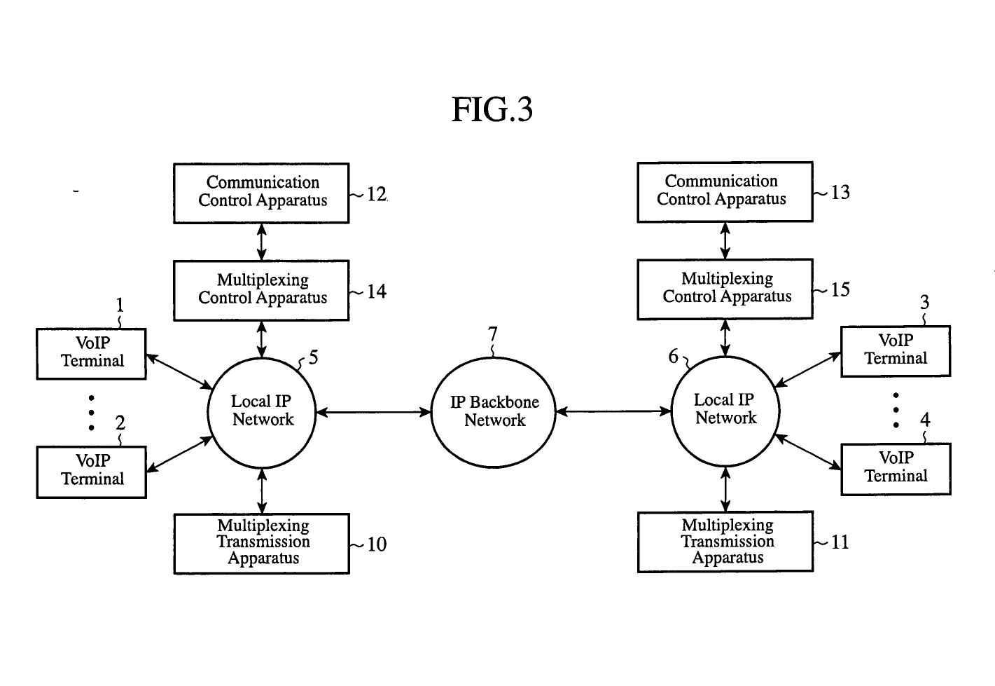

FIG. 3 is a block diagram showing a packet communication system in accordance with embodiment 2 of the present invention. In the figure, the same reference numerals as shown in FIG. 1 denote the same components or like components, and therefore the explanation of the components will be omitted hereafter.

For example, when receiving a connection request including the telephone number of a VoIP terminal 2 from a VoIP terminal 1, a communication control apparatus 12 searches for the IP address of the VoIP terminal 2. When receiving a connection request including the telephone numbers of VoIP terminals 3 and 4 from the VoIP terminal 1, the communication control apparatus 12 searches for the IP address of a communication control apparatus 13 which manages the VoIP terminals 3 and 4. For example, when receiving a connection request including the telephone number of the VoIP terminal 4 from the VoIP terminal 3, the communication control apparatus 13 searches for the IP address of the VoIP terminal 4. When receiving a connection request including the telephone numbers of the VoIP terminals 1 and 2 from the VoIP terminal 3, the communication control apparatus 13 searches for the IP address of the communication control apparatus 12 which manages the VoIP terminals 1 and 2.

When the communication control apparatus 12 searches for the IP address of the communication control apparatus 13, a multiplexing control apparatus 14 identifies both a multiplexing transmission apparatus 11 corresponding to the communication control apparatus 13, and a multiplexing transmission apparatus 10 which manages the VoIP terminal 1 which is the transmission source of the connection request, and notifies the IP address of the multiplexing transmission apparatus 11 and the IP address of the VoIP terminal 4 to the multiplexing transmission apparatus 10. When the communication control apparatus 13 searches for the IP address of the communication control apparatus 12, a multiplexing control apparatus 15 identifies both the multiplexing transmission apparatus 10 corresponding to the communication control apparatus 12, and the multiplexing transmission apparatus 11 which manages the VoIP terminal 3 which is the transmission source of the connection request, and notifies the IP address of the multiplexing transmission apparatus 10 and the IP address of the VoIP terminal 1 to the multiplexing transmission apparatus 11.

Next, the operation of the packet communication system in accordance with this embodiment of the present invention will be explained.

For example, when the user of the VoIP terminal 1 dials the telephone number of the VoIP terminal 4, the VoIP terminal 1 transmits a connection request packet including the destination telephone number (i.e., the telephone number of the VoIP terminal 4) to the multiplexing control apparatus 14.

When receiving the connection request packet including the destination telephone number (i.e., the telephone number of the VoIP terminal 4) from the VoIP terminal 1, the multiplexing control apparatus 14 transmits the connection request packet to the communication control apparatus 12, and also stores the connection request packet therein temporarily.

When receiving the connection request packet including the destination telephone number (i.e., the telephone number of the VoIP terminal 4) from the multiplexing control apparatus 14, the communication control apparatus 12 searches for an IP address corresponding to the telephone number of the VoIP terminal 4. In other words, because the VoIP terminal 4 is not a VoIP terminal which the communication control apparatus 12 manages, the communication control apparatus 12 searches for the IP address of the communication control apparatus 13 which manages the VoIP terminal 4 and sends the searched result to the multiplexing control apparatus 14.

In contrast, when the destination telephone number is the telephone number of a VoIP terminal (for example, the VoIP terminal 2) which the communication control apparatus 12 manages, the communication control apparatus 12 searches for the IP address of the VoIP terminal 2 and transmits the searched result to the VoIP terminal 2 which is the transmission destination.

The communication control apparatus 12 manages the telephone numbers and IP addresses of the VoIP terminals 1 to 4 each of which is connected to either of the local IP networks 5 and 6, and the IP address of the communication control apparatus 13.

When receiving the IP address of the communication control apparatus 13 from the communication control apparatus 12, the multiplexing control apparatus 14 identifies the multiplexing transmission apparatus 11 corresponding to the communication control apparatus 13, and also identifies the multiplexing transmission apparatus 10 which manages the VoIP terminal 1 which is the transmission source of the connection request packet.

The multiplexing control apparatus 14 then incorporates the IP address of the multiplexing transmission apparatus 10 which manages the VoIP terminal 1 which is the transmission source into the connection request packet which the multiplexing control apparatus 14 has received from the VoIP terminal 1, and transmits the connection request packet to the multiplexing control apparatus 15.

The multiplexing control apparatus 14 recognizes the IP address of the multiplexing control apparatus 15 which manages the communication control apparatus 13 in advance.

When receiving the connection request packet including the IP address of the multiplexing transmission apparatus 10 from the multiplexing control apparatus 14, the multiplexing control apparatus 15 temporarily stores the IP address of the multiplexing transmission apparatus 10 therein, erases the IP address of the multiplexing transmission apparatus 10 from the connection request packet, and transmits the connection request packet from which the IP address of the multiplexing transmission apparatus 10 is erased to the communication control apparatus 13.

When receiving connection request packet including the destination telephone number (i.e., the telephone number of the VoIP terminal 4) from the multiplexing control apparatus 15, the communication control apparatus 13 searches for the IP address corresponding to the telephone number of the VoIP terminal 4.

When receiving the IP address searched for by the communication control apparatus 13, the multiplexing control apparatus 15 refers to the IP address and identifies the multiplexing transmission apparatus 11 which manages the VoIP terminal 4 which is the destination, and also identifies the multiplexing transmission apparatus 10 which manages the VoIP terminal 1 which is the transmission source of the connection request packet.

The multiplexing control apparatus 15 then incorporates the IP address of the multiplexing transmission apparatus 11 which manages the VoIP terminal 4 into the connection request packet which the multiplexing control apparatus 15 has received from the multiplexing control apparatus 14 (i.e., replaces the IP address of the VoIP terminal 1 which is originally included in the connection request packet with the IP address of the multiplexing transmission apparatus 11), and transmits the connection request packet to the VoIP terminal 4.

When receiving the connection request packet from the multiplexing control apparatus 15, the VoIP terminal 4 transmit a connection grant packet to the multiplexing control apparatus 15 if it is placed in a state in which it can establish a connection with another VoIP terminal (for example, in a state in which it is not communicating with any other VoIP terminal).

When receiving the connection grant packet from the VoIP terminal 4, the multiplexing control apparatus 15 transmits the connection grant packet to the communication control apparatus 13, incorporates the IP address of the multiplexing transmission apparatus 11 which manages the VoIP terminal 4 into the connection grant packet, and then transmits it to the multiplexing control apparatus 14.

When receiving the connection grant packet including the IP address of the multiplexing transmission apparatus 11 from the multiplexing control apparatus 15, the multiplexing control apparatus 14 temporarily stores the IP address of the multiplexing transmission apparatus 11 therein, erases the IP address of the multiplexing transmission apparatus 11 from the connection grant packet, and transmits the connection grant packet from which the IP address of the multiplexing transmission apparatus 11 is erased to the communication control apparatus 12.

The multiplexing control apparatus 14 then incorporates the IP address of the multiplexing transmission apparatus 10 which manages the VoIP terminal 1 which is the source of the connection request into the connection grant packet which the multiplexing control apparatus 14 has received from the multiplexing control apparatus 15 (i.e., replaces the IP address of the VoIP terminal 4 which is originally included in the connection grant packet with the IP address of the multiplexing transmission apparatus 10), and transmits the connection grant packet to the VoIP terminal 1.

When transmitting the connection grant packet to the VoIP terminal 1 in the above-mentioned way, the multiplexing control apparatus 14 transmits multiplexing information to the multiplexing transmission apparatus 10.

In other words, the multiplexing control apparatus 14 notifies, as the multiplexing information, the IP address of the VoIP terminal 1 which is the transmission source of IP packets, the IP address of the multiplexing transmission apparatus 11 which is the transmission destination of multiplexed packets (i.e., the IP address extracted from the connection grant packet and stored therein), and the IP address of the VoIP terminal 4 which is the final destination to the multiplexing transmission apparatus 10.

The multiplexing control apparatus 14 also transmits multiplexing information to the multiplexing transmission apparatus 11.

In other words, the multiplexing control apparatus 14 notifies, as the multiplexing information, the IP address of the VoIP terminal 4 which is the transmission source of IP packets, the IP address of the multiplexing transmission apparatus 10 which is the transmission destination of multiplexed packets (i.e., the IP address extracted from the connection request packet and stored therein), and the IP address of the VoIP terminal 1 which is the final destination to the multiplexing transmission apparatus 11.

After that, the VoIP terminal 1 transmits and receives packets to and from the VoIP terminal 4 by way of the multiplexing transmission apparatus 10 and 11. Because this packet transmission-and-reception operation is the same as that of the packet communication system according to above-mentioned embodiment 1, the explanation of the packet transmission-and-reception operation will be omitted hereafter.

Although the packet communications between the VoIP terminal 1 and the VoIP terminal 4 are thus established, the multiplexing control apparatus 14 needs to recognize a correspondence between the VoIP terminals 1 and 2 and the multiplexing transmission apparatus 10 in advance and the multiplexing control apparatus 15 needs to recognize a correspondence between the VoIP terminals 3 and 4 and the multiplexing transmission apparatus 11 in advance in order that such packet communications are established between VoIP terminals.

For this reason, when the multiplexing transmission apparatus 10 is installed on the network, the IP addresses of the VoIP terminals 1 and 2 and the IP address of the multiplexing transmission apparatus 10 are set up for the multiplexing control apparatus 14. Similarly, when the multiplexing transmission apparatus 11 is installed on the network, the IP addresses of the VoIP terminals 3 and 4 and the IP address of the multiplexing transmission apparatus 11 are set up for the multiplexing control apparatus 15. However, because a method of setting up IP addresses are the same as that of above-mentioned embodiment 1, the explanation of the method will be omitted hereafter.

The multiplexing control apparatus 14 needs to recognize the IP address of the multiplexing control apparatus 15 in advance, and the multiplexing control apparatus 15 needs to recognize the IP address of the multiplexing control apparatus 14 in advance. Therefore, when the multiplexing control apparatus 14 and 15 are installed on the network, their IP addresses are set up.

In this embodiment 2, the case in which the VoIP terminals 1 and 4 transmit and receive packets to and from each other is explained as an example. In contrast, in a case in which VoIP terminals which are managed by the same multiplexing transmission apparatus 10 transmit and receive packets to and from each other, for example, in a case in which the VoIP terminals 1 and 2 transmit and receive packets to and from each other, the multiplexing control apparatus 14 does not transmit multiplexing information to the multiplexing transmission apparatus 10. In such a case, the VoIP terminals 1 and 2 are made to communicate voice packets directly to each other, not by way of the multiplexing transmission apparatus 10 and 11.

As can be seen from the above description, in accordance with this embodiment 2, in a case in which a plurality of communication control apparatus and a plurality of multiplexing control apparatus are installed on the network, each communication control apparatus searches for the address of another communication control apparatus from the destination telephone number, and each multiplexing control apparatus identifies a multiplexing transmission apparatus corresponding to the other communication control apparatus, and a multiplexing transmission apparatus which manages a terminal device which is the transmission source of the connection request. Therefore, the present embodiment offers the same advantages as provided by above-mentioned embodiment 1 even in the case in which the plurality of communication control apparatus and the plurality of multiplexing control apparatus are installed on the network.

### Embodiment 3

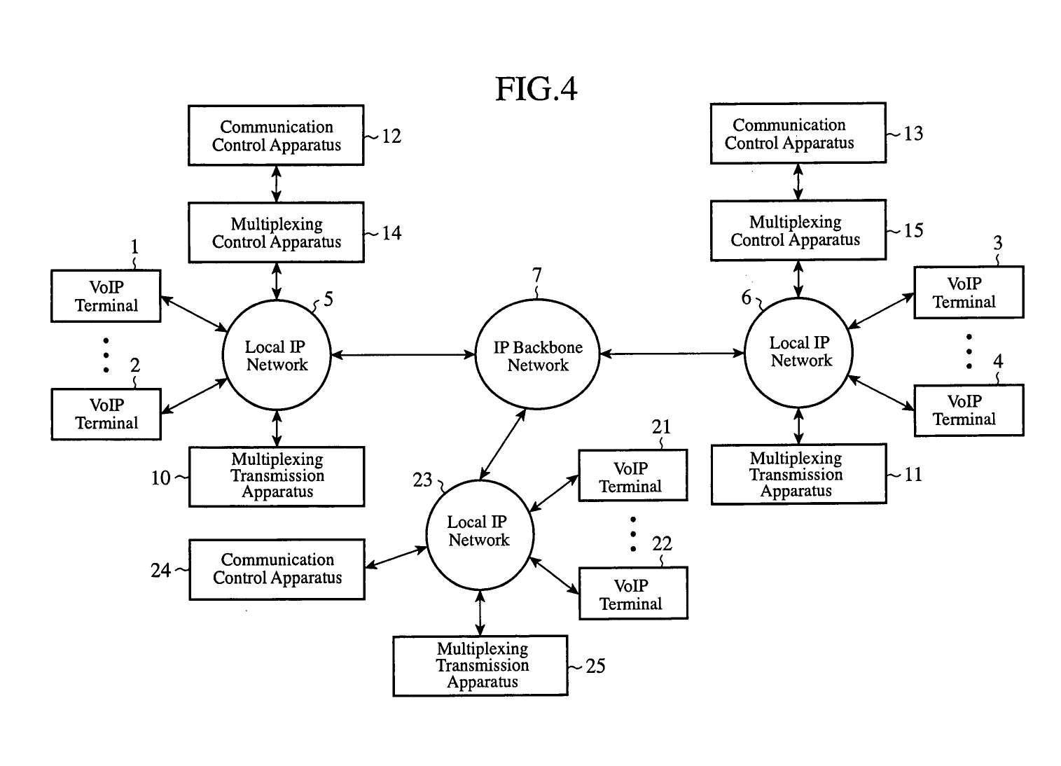

In above-mentioned embodiment 2, the multiplexing control apparatus 14 and 15 are installed in the local IP networks 5 and 6, respectively, as previously mentioned. As shown in FIG. 4, there may be a case in which no multiplexing control apparatus is installed in a local IP network 23. In FIG. 4, each of VoIP terminals 21 and 22 has the same structure as a VoIP terminal 1, a communication control apparatus 24 has the same structure as a communication control apparatus 12, and a multiplexing transmission apparatus 25 has the same structure as a multiplexing transmission apparatus 10.

In accordance with this embodiment 3, when the VoIP terminal 1 carries out communications of packets with the VoIP terminal 21 or 22, a multiplexing control apparatus 14 transfers a control packet (e.g., a connection request packet or a connection grant packet) which it has received from the VoIP terminal 1 to the VoIP terminal 21 or 22 without replacing the IP address of the VoIP terminal 1 which is included in the control packet, the VoIP terminal 1 being the transmission source of the control packet, with the IP address of the multiplexing transmission apparatus 10 which the multiplexing control apparatus 14 manages.

Concretely, the multiplexing control apparatus 14 operates as follows.

For example, in a case of communications of packets with the VoIP terminal 4, the VoIP terminal 1 carries out communications of packets with the VoIP terminal 4 by way of the multiplexing transmission apparatus 10 and 11 in the same way as explained in above-mentioned embodiment 2.

However, in the case in which the VoIP terminal 1 carries out communications of packets with the VoIP terminal 21, a control packet which the multiplexing control apparatus 14 receives from the local IP network 23 does not additionally include the IP address of the multiplexing transmission apparatus 25 because no multiplexing control apparatus is installed in the local IP network 23. For this reason, the multiplexing control apparatus 14 cannot acquire multiplexing information which it will notify to the multiplexing transmission apparatus 10 which the multiplexing control apparatus 14 manages, and therefore cannot carry out packet communications via a multiplexing transmission apparatus, unlike that of above-mentioned embodiment 2.

Therefore, in accordance with this embodiment 3, in a case in which, for example, the VoIP terminal 1 carries out communications of packets with the VoIP terminal 21 or 22, the multiplexing control apparatus 14 transfers a control packet (e.g., a connection request packet or a connection grant packet) which it has received from the VoIP terminal 1 to the VoIP terminal 21 or 22 without replacing the IP address of the VoIP terminal 1 which is included in the control packet, the VoIP terminal 1 being the transmission source of the control packet, with the IP address of the multiplexing transmission apparatus 10 which the multiplexing control apparatus 14 manages.

As a result, the VoIP terminal 1 can carry out communications of packets directly with the VoIP terminal 21 or 22 without using the multiplexing transmission apparatus 10 and 25.

Thus, this embodiment 3 offers an advantage of being able to carry out packet communications with a VoIP terminal such as the VoIP terminal 21 or 22 connected to the local IP network 23 in which no multiplexing control apparatus is installed.

### Embodiment 4

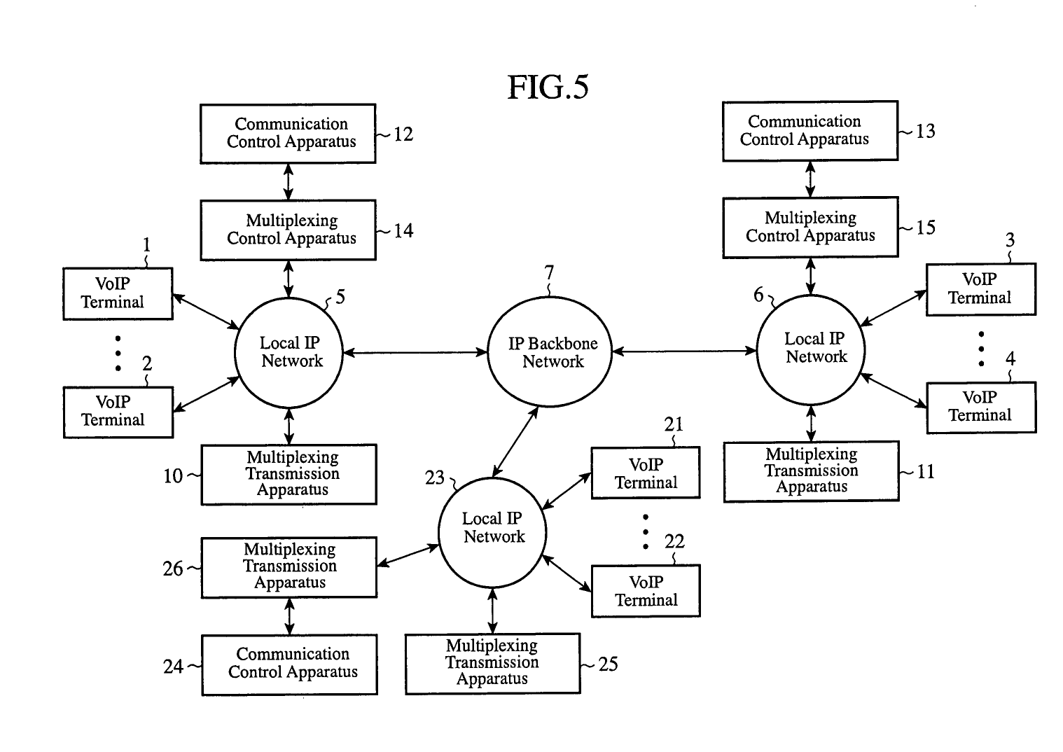

In above-mentioned embodiment 3, no multiplexing control apparatus is installed in the local IP network 23, as previously mentioned. As an alternative, a new multiplexing control apparatus 26 can be added to the local IP network 23, as shown in FIG. 5.

In the case in which the new multiplexing control apparatus 26 is added to the local IP network 23, the multiplexing control apparatus 26 notifies the existing multiplexing control apparatus 14 and 15 that the new multiplexing control apparatus 26 is added to the local IP network 23.

Concretely, the multiplexing control apparatus 26 operates as follows.

When the multiplexing control apparatus 26 is added to the local IP network 23, because the packet communication system needs to recognize a correspondence between the VoIP terminals 21 and 22 which are connected to the local IP network 23 and the multiplexing transmission apparatus 25, as mentioned above, the IP addresses of the VoIP terminals 21 and 22 and the IP address of the multiplexing transmission apparatus 25 are set up for the multiplexing control apparatus 26.

Furthermore, the IP addresses of the multiplexing control apparatus 14 and 15 are also set up for the multiplexing control apparatus 26.

When the multiplexing control apparatus 26 starts its operation, the multiplexing control apparatus 26 notifies the multiplexing control apparatus 14 and 15 that the multiplexing control apparatus 26 is added to the local IP network.

As a result, the multiplexing control apparatus 14 and 15 recognize that the multiplexing control apparatus 26 is added to the network, and then acquire the IP address of the multiplexing control apparatus 26.

This embodiment 4 offers an advantage of, when adding the multiplexing control apparatus 26 to the network, being able to set up the IP address of the multiplexing control apparatus 26 for the multiplexing control apparatus 14 and 15 automatically.

### Embodiment 5

In above-mentioned embodiments 1 to 4, each terminal device is a VoIP terminal, as previously explained. However, each terminal device is not limited to a VoIP terminal. For example, each terminal device can be a gateway which accommodates a telephone circuit.

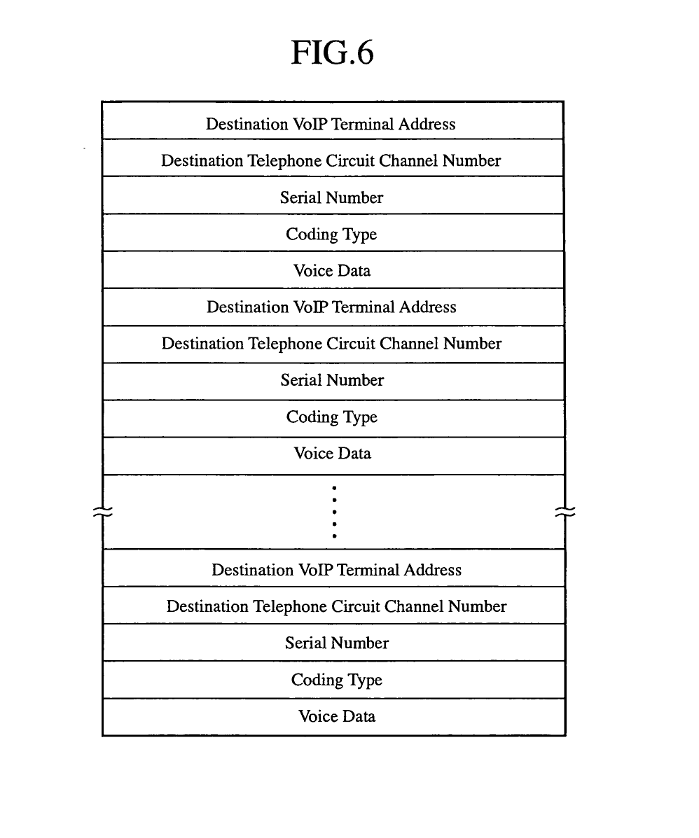

In this case, because the channel number of the destination telephone circuit needs to be stored in the header of multiplexed short packets, each packet output from the multiplexing transmission apparatus 10 or 11, or the like has a payload as shown in FIG. 6.

### Embodiment 6

In accordance with above-mentioned embodiment, the connection type of voice call passes and the format of messages exchanged between a VoIP terminal and the communication control apparatus 8 use a communication control method called VoIP signaling.

As the communication control method, such a protocol as SIP or MEGACO can be applied to the system, as previously explained. In this embodiment 6, the operation of the packet communication system at the time of using the SIP protocol will be explained.

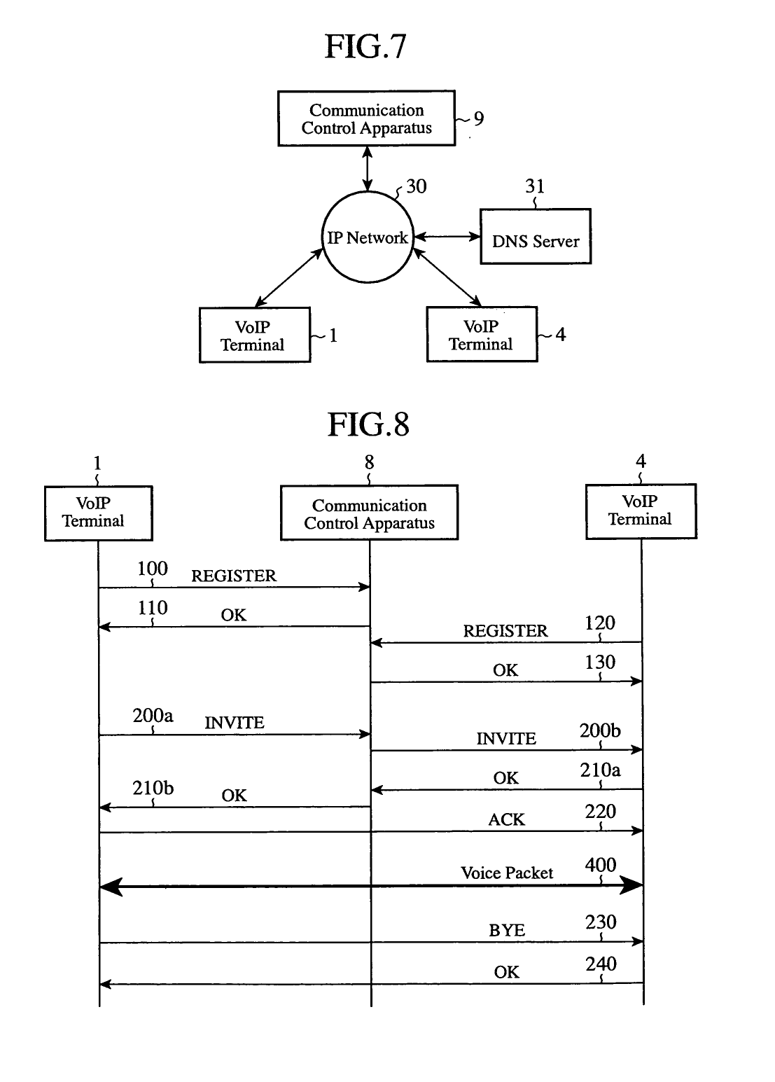

First, before an explanation of the operation of the packet communication system according to this embodiment 6 will be concretely made, a fundamental communication control operation according to the SIP will be briefly explained. FIG. 7 is a schematic block diagram showing the packet communication system which carries out communication control according to the SIP protocol, and FIG. 8 is a sequence diagram showing the communications protocol of the packet communication system.

In a structure in which a VoIP terminal 1 and a VoIP terminal 4 are connected to an IP network 30 (which corresponds to the local networks 5 and 6 and IP backbone network 7 of FIG. 1), as shown in FIG. 7, when the VoIP terminals 1 and 4 make a call connection with each other according to the SIP protocol, an SIP message is transmitted between the VoIP terminals 1 and 4 via a communication control apparatus 8.

The communication control apparatus 8 which is used when communication control is carried out according to the SIP protocol is called an SIP server, and this communication control apparatus 8 has a function of serving as a proxy server which transfers an SIP message transmitted between the VoIP terminals, and a function of serving as a registration server which receives a registration of position information about each VoIP terminal on the IP network.

First, when the user of the VoIP terminal 1 switches on the power supply of the VoIP terminal 1, the VoIP terminal 1 transmits a REGISTER message 100 (i.e., a registration message) including its own IP address to the communication control apparatus 8.

When receiving the REGISTER message 100 from the VoIP terminal 1, the communication control apparatus 8 registers the IP address of the VoIP terminal 1 included in the REGISTER message 100. In other words, the communication control apparatus 8 registers position information on the VoIP terminal 1.

The communication control apparatus 8 also transmits an O.K. message 110 to the VoIP terminal 1 in order to notify that the communication control apparatus 8 has received the REGISTER message 100 normally.

Similarly, when the user of the VoIP terminal 4 switches on the power supply of the VoIP terminal 4, the VoIP terminal 4 transmits a REGISTER message 120 including its own IP address to the communication control apparatus 8.

When receiving the REGISTER message 120 from the VoIP terminal 4, the communication control apparatus 8 registers the IP address of the VoIP terminal 4 included in the REGISTER message 120. In other words, the communication control apparatus 8 registers position information on the VoIP terminal 41.

The communication control apparatus 8 also transmits an O.K. message 130 to the VoIP terminal 4 in order to notify that the communication control apparatus 8 has received the REGISTER message 120 normally.

After the registration of the two pieces of position information on the VoIP terminals 1 and 4 is completed in the above-mentioned way, the communication control apparatus 8 enters a state in which it can transfer an SIP message transmitted from the VoIP terminal 1 or 4 to the VoIP terminal 4 or 1.

After that, when the user of the VoIP terminal 1 wishes a telephone call with the VoIP terminal 4 and dials the telephone number of the VoIP terminal 4, the VoIP terminal 1 transmits an INVITE message 200a (i.e., a connection request packet) including the IP address of the party on the other end of the connection (i.e., the VoIP terminal 4) with which the VoIP terminal 1 desires to communicate to the communication control apparatus 8.

When receiving the INVITE message 200a from the VoIP terminal 1, the communication control apparatus 8 transfers the INVITE message 200a, as an INVITE message 200b, to the VoIP terminal 4.

When transmitting the INVITE message 200a to the communication control apparatus 8, the VoIP terminal 1 needs to get to know the IP address of the VoIP terminal 4 in advance. For example, the VoIP terminal 1 can know the IP address of the VoIP terminal 4 by inquiring of a DNS server 31 about the IP address corresponding to the telephone number of the VoIP terminal 4.

When receiving the INVITE message 200b from the communication control apparatus 8, the VoIP terminal 4 transmits an O.K. message 210a including the IP address of the party on the other end of the connection (i.e., the VoIP terminal 1) which has desired to communicate therewith to the communication control apparatus 8 in order to notify that the VoIP terminal 4 has received the INVITE message 200b normally.

When receiving the O.K. message 210a from the VoIP terminal 4, the communication control apparatus 8 transfers the O.K. message 210a, as an O.K. message 210b, to the VoIP terminal 1.

When receiving the O.K. message 210b from the communication control apparatus 8, the VoIP terminal 1 transmits an ACK message 220 to the VoIP terminal 4 in order to notify that the VoIP terminal 1 has received the O.K. message 210b normally.

This ACK message 220 can be directly transmitted to the VoIP terminal 4 without being passed via the communication control apparatus 8. However, if an instruction for adding a Record-Route header (information about a transmission route of messages) which indicates the IP address of the communication control apparatus 8 to the INVITE message 200b to transmit all subsequent SIP messages which will be transmitted between the VoIP terminals 1 and 4 by way of the communication control apparatus 8 is provided when the communication control apparatus 8 transmits the INVITE message 200b to the VoIP terminal 4, the ACK message 220 can be transmitted to the VoIP terminal 4 via the communication control apparatus 8.

After the INVITE message 200, O.K. message 210, and ACK message 220 are exchanged in the above-mentioned way, a session is established between the VoIP terminal 1 and the VoIP terminal 4, and they are placed in a state where they can communicate with each other. After that, transmission and reception of voice packets 400 are started between the VoIP terminal 1 and the VoIP terminal 4.

In this exchange of the INVITE message 200, O.K. message 210, and ACK message 220, session information based on SDP (Session Definition Protocol) is incorporated into an SIP message so that the setting of the type of a voice codec which is used for communications between the VoIP terminals 1 and 4, the IP address of the transmission destination of voice packets, etc. is carried out.

In general, the exchange of the session information based on the SDP is carried out with the INVITE message 200 and O.K. message 210. However, in a case in which the session information based on the SDP is not incorporated into the INVITE message 200, the exchange of the session information based on the SDP is carried out by incorporating the session information based on the SDP into the O.K. message 210 and ACK message 220.

After that, when the users of the VoIP terminals 1 and 4 finish the telephone call between them, and either of the caller and receiver, for example, the user of the VoIP terminal 1 makes the VoIP terminal 1 be on-hook to make the VoIP terminal 1 perform call release processing, the VoIP terminal 1 transmits a BYE message 230 to the VoIP terminal 4.

When receiving the BYE message 230 from the VoIP terminal 1, the VoIP terminal 4 transmits an O.K. message 240 to the VoIP terminal 1 in order to notify the VoIP terminal 1 that the VoIP terminal 4 has received the BYE message 230 normally. As a result, the communications between the VoIP terminals 1 and 4 is finished.

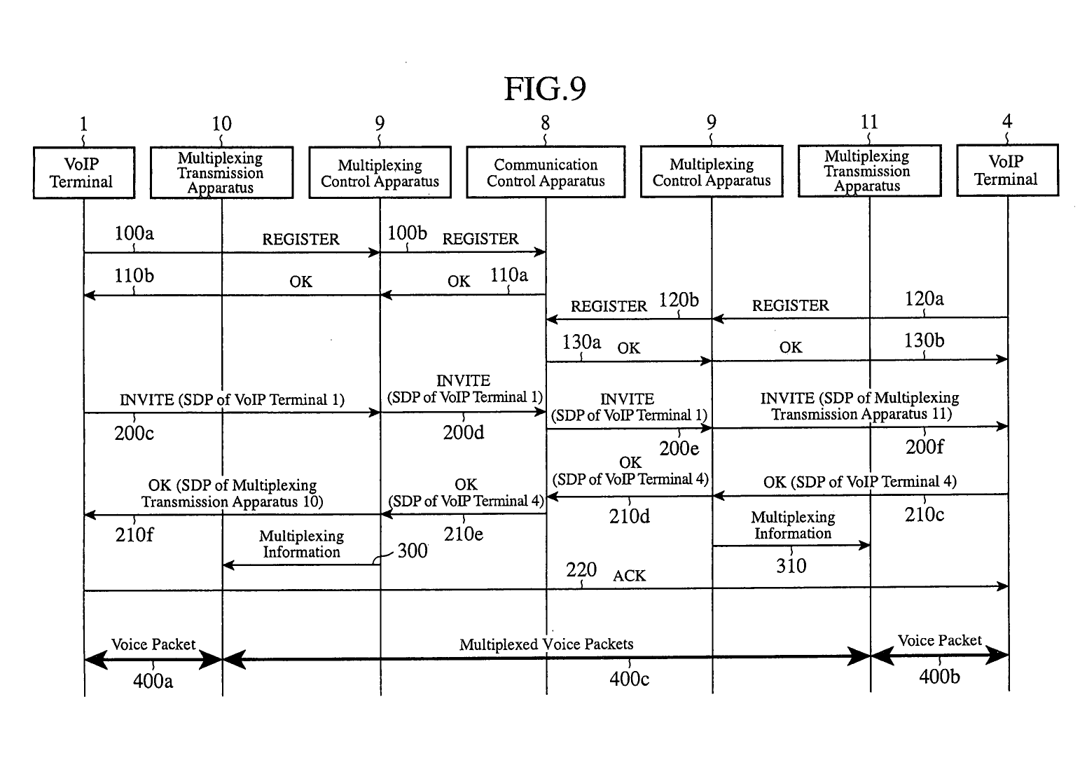

Next, an operation of the packet communication system shown in FIG. 1 at the time of using the SIP protocol as a communication control procedure will be explained concretely. FIG. 9 is a sequence diagram showing the communications protocol of the packet communication system in accordance with embodiment 6 of the present invention.

First, when the user of the VoIP terminal 1 switches on the power supply of the VoIP terminal 1, the VoIP terminal 1 transmits a REGISTER message 100a including its own IP address to the communication control apparatus 8 via the local IP network 5. Because the multiplexing control apparatus 9 exists on a transmission line extending from the VoIP terminal 1 to the communication control apparatus 8, the multiplexing control apparatus 9 receives the REGISTER message 100a transmitted from the VoIP terminal 1 before the communication control apparatus 8 receives the REGISTER message 100a.

When receiving the REGISTER message 100a from the VoIP terminal 1, the multiplexing control apparatus 9 transfers the REGISTER message 100a, as a REGISTER message 100b, to the communication control apparatus 8.

When receiving the REGISTER message 100b from the multiplexing control apparatus 9, the communication control apparatus 8 registers the IP address of the VoIP terminal 1 included in the REGISTER message 100b. In other words, the communication control apparatus 8 registers position information on the VoIP terminal 1.

The communication control apparatus 8 transmits an O.K. message 110a to the VoIP terminal 1 in order to notify the VoIP terminal 1 that the communication control apparatus 8 has received the REGISTER message 100b normally. Because the multiplexing control apparatus 9 exists on the transmission line extending from the communication control apparatus 8 to the VoIP terminal 1, the multiplexing control apparatus 9 receives the OK message 110a transmitted from the communication control apparatus 8 before the VoIP terminal 1 receives the OK message 110a.

When receiving the O.K. message 110a from the communication control apparatus 8, the multiplexing control apparatus 9 transfers the O.K. message 110a, as an O.K. message 110b, to the VoIP terminal 1 via the local IP network 5.

Similarly, when the user of the VoIP terminal 4 switches on the power supply of the VoIP terminal 4, the VoIP terminal 4 transmits a REGISTER message 120a including its own IP address to the communication control apparatus 8 via the local IP network 6, IP backbone network 7, and local IP network 5. Because the multiplexing control apparatus 9 exists on a transmission line extending from the VoIP terminal 4 to the communication control apparatus 8, the multiplexing control apparatus 9 receives the REGISTER message 120a transmitted from the VoIP terminal 4 before the communication control apparatus 8 receives the REGISTER message 120a.

When receiving the REGISTER message 120a from the VoIP terminal 4, the multiplexing control apparatus 9 transfers the REGISTER message 120a, as a REGISTER message 120b, to the communication control apparatus 8.

When receiving the REGISTER message 120b from the multiplexing control apparatus 9, the communication control apparatus 8 registers the IP address of the VoIP terminal 4 included in the REGISTER message 120b. In other words, the communication control apparatus 8 registers the position information on the VoIP terminal 4.

The communication control apparatus 8 transmits an O.K. message 130a to the VoIP terminal 4 in order to notify the VoIP terminal 4 that the communication control apparatus 8 has received the REGISTER message 120b normally. Because the multiplexing control apparatus 9 exists on the transmission line extending from the communication control apparatus 8 to the VoIP terminal 4, the multiplexing control apparatus 9 receives the OK message 130a transmitted from the communication control apparatus 8 before the VoIP terminal 4 receives the OK message 130a.

When receiving the O.K. message 130a from the communication control apparatus 8, the multiplexing control apparatus 9 transfers the O.K. message 130a, as an O.K. message 130b, to the VoIP terminal 4 via the local IP network 5, IP backbone network 7, and local IP network 6.

When the registration of the two pieces of the position information on the VoIP terminals 1 and 4 is completed in the above-mentioned way, the communication control apparatus 8 is enabled to transfer a subsequent SIP message transmitted from the VoIP terminal 1 or 4 to the VoIP terminal 4 or 1.

When the user of the VoIP terminal 1 wishes to make a telephone call with the VoIP terminal 4 and dials the telephone number of the VoIP terminal 4, the VoIP terminal 1 transmits an INVITE message 200c including the IP address of the party on the other end over of the connection (i.e., the VoIP terminal 4) with which the VoIP terminal 4 desires to communicate to the communication control apparatus 8 via the local IP network 5. Because multiplexing control apparatus 9 exists on the transmission line extending from the VoIP terminal 1 to the communication control apparatus 8, the multiplexing control apparatus 9 receives the INVITE message 200c transmitted from the VoIP terminal 1 before the communication control apparatus 8 receives the INVITE message 200c.

Session information based on the SDP is incorporated into this INVITE message 200c, and the IP address of the VoIP terminal 1 is described in the SDP message as the IP address of the transmission destination of voice packets transmitted from the communications partner (i.e., the VoIP terminal 4).

When receiving the INVITE message 200c from the VoIP terminal 1, the multiplexing control apparatus 9 transfers the INVITE message 200c, as an INVITE message 200d, to the communication control apparatus 8.

When receiving the INVITE message 200d from the multiplexing control apparatus 9, the communication control apparatus 8 transfers the INVITE message 200d, as an INVITE message 200e, to the VoIP terminal 4. Because the multiplexing control apparatus 9 exists on the transmission line extending from the communication control apparatus 8 to the VoIP terminal 4, the multiplexing control apparatus 9 receives the INVITE message 200e transferred from the communication control apparatus 8 before the VoIP terminal 4 receives the INVITE message 200e.

In this case, a Record-Route header indicating the IP address of the communication control apparatus 8 is not added to the INVITE message 200e when the INVITE message 200e is transferred to the VoIP terminal 4.

When receiving the INVITE message 200e from the communication control apparatus 8, the multiplexing control apparatus 9 rewrites the session information based on the SDP which is included in the INVITE message 200e.

In other words, because the IP address of the VoIP terminal 1 is described, as the IP address of the transmission destination of voice packets transmitted from the communications partner (i.e., the VoIP terminal 4), in the session information based on the SDP which is included in the INVITE message 200e, the multiplexing control apparatus 9 replaces the IP address of the VoIP terminal 1 with the IP address of the multiplexing transmission apparatus 11.

The multiplexing control apparatus 9 transmits the rewritten INVITE message 200e, as an INVITE message 200f, to the VoIP terminal 4 via the local IP network 5, IP backbone network 7, and local IP network 6.

When receiving the INVITE message 200f from the multiplexing control apparatus 9, the VoIP terminal 4 transmits an O.K. message 210c including the IP address of the party on the other end of the connection (i.e., the VoIP terminal 1) which has desired to communicate with the VoIP terminal 4 to the communication control apparatus 8 via the local IP network 6, IP backbone network 7, and local IP network 5 in order to notify the multiplexing control apparatus 9 that the VoIP terminal 4 has received the INVITE message 200f normally. Because the multiplexing control apparatus 9 exists on the transmission line extending from the VoIP terminal 4 to the communication control apparatus 8, the multiplexing control apparatus 9 receives the O.K. message 210c transmitted from the VoIP terminal 4 before the communication control apparatus 8 receives the O.K. message 210c.

Session information based on the SDP is incorporated into this O.K. message 210c, and the IP address of the VoIP terminal 4 is described in the SDP message as the IP address of the transmission destination of voice packets transmitted from the communications partner (i.e., the VoIP terminal 1).

When receiving the O.K. message 210c from the VoIP terminal 4, the multiplexing control apparatus 9 transfers the O.K. message 210c, as an O.K. message 210d, to the communication control apparatus 8.

When receiving the O.K. message 210d from the multiplexing control apparatus 9, the communication control apparatus 8 transfers the O.K. message 210d, as an O.K. message 210e, to the VoIP terminal 1. Because the multiplexing control apparatus 9 exists on the transmission line extending from the communication control apparatus 8 to the VoIP terminal 1, the multiplexing control apparatus 9 receives the O.K. message 210e transferred from the communication control apparatus 8 before the VoIP terminal 1 receives the O.K. message 210e.

When receiving the O.K. message 210e from the communication control apparatus 8, the multiplexing control apparatus 9 rewrites the session information based on the SDP which is included in the O.K. message 210e.

In other words, because the IP address of the VoIP terminal 4 is described, as the IP address of the transmission destination of voice packets transmitted from the communications partner (i.e., the VoIP terminal 1), in the session information based on the SDP which is included in the O.K. message 210e, the multiplexing control apparatus 9 replaces the IP address of the VoIP terminal 4 with the IP address of the multiplexing transmission apparatus 10.

The multiplexing control apparatus 9 transmits the rewritten O.K. message 210e, as an O.K. message 210f, to the VoIP terminal 1 via the local IP network 5.

After transmitting the O.K. message 210f to the VoIP terminal 1, the multiplexing control apparatus 9 transmits multiplexing information 300 to the multiplexing transmission apparatus 10 via the local IP network 5, and also transmits multiplexing information 310 to the multiplexing transmission apparatus 11 via the local IP network 5, IP backbone network 7, and local IP network 6.

The IP address of the VoIP terminal 1 which is the transmission source of IP packets, the IP address of the multiplexing transmission apparatus 11 which is the transmission destination of multiplexed IP packets, and the IP address of the VoIP terminal 4 which is the final destination are included in the multiplexing information 300 transmitted to the multiplexing transmission apparatus 10.

The IP address of the VoIP terminal 4 which is the transmission source of IP packets, the IP address of the multiplexing transmission apparatus 10 which is the transmission destination of multiplexed IP packets, and the IP address of the VoIP terminal 1 which is the final destination are included in the multiplexing information 310 transmitted to the multiplexing transmission apparatus 11.

When receiving the O.K. message 210f from the multiplexing control apparatus 9, the VoIP terminal 1 transmits an ACK message 220 to the VoIP terminal 4 in order to notify the multiplexing control apparatus 9 that the VoIP terminal 1 has received the O.K. message 210f normally.

Because a Record-Route header indicating the IP address of the communication control apparatus 8 is not added to the INVITE message 200e when the communication control apparatus 8 transfers the INVITE message 200e to the VoIP terminal 4, as mentioned above, this ACK message 220 is directly transmitted to the VoIP terminal 4 without being passed via the communication control apparatus 8.

The VoIP terminals 1 and 4 recognize the establishment of communications when the transmission of the ACK message 220 is completed in the above-mentioned way. At that time, because the multiplexing control apparatus 9 rewrites the session information based on the SDP which is included in the O.K. message 210e, the VoIP terminal 1 recognizes that the transmission destination of the voice packets is the multiplexing transmission apparatus 10, and, after that, transmits the voice packets to the multiplexing transmission apparatus 10.

When receiving the voice packets from the VoIP terminal 1, the multiplexing transmission apparatus 10 multiplexes the voice packets. In this case, when also receiving voice packets from another VoIP terminal other than the VoIP terminal 1 (e.g., the VoIP terminal 2), the multiplexing transmission apparatus 10 extracts short packets from the plurality of voice packets, collects short packets which are destined for an identical multiplexing transmission apparatus from the extracted short packets, and multiplexes and IP-packetizes the collected short packets again.

Similarly, because the multiplexing control apparatus 9 rewrites the session information based on the SDP which is included in the INVITE message 200e, the VoIP terminal 4 recognizes that the transmission destination of the voice packets is the multiplexing transmission apparatus 11, and, after that, transmits the voice packets to the multiplexing transmission apparatus 11.

When receiving the voice packets from the VoIP terminal 4, the multiplexing transmission apparatus 11 multiplexes the voice packets. In this case, when also receiving voice packets from another VoIP terminal other than the VoIP terminal 4 (e.g., the VoIP terminal 3), the multiplexing transmission apparatus 11 extracts short packets from the plurality of voice packets, collects short packets which are destined for an identical multiplexing transmission apparatus from the extracted short packets, and multiplexes and IP-packetizes the collected short packets again.

As can be seen from the above description, in accordance with this embodiment 6, the multiplexing control apparatus 9 rewrites the session information based on the SDP which is included in an SIP message transmitted between the VoIP terminals 1 and 4, and makes the VoIP terminal 4 or 1 recognize that the transmission destination of voice packets transmitted from the VoIP terminal 1 or 4 is the multiplexing transmission apparatus 10 or 11. Therefore, the present embodiment offers an advantage of being able to enable the multiplexing transmission apparatus 10 and 11 to multiplex the voice packets, and therefore to reduce the overhead of IP packets without causing increase in the transmission delay of the voice packets even when many VoIP terminals are connected to the local IP networks 5 and 6.

### Embodiment 7

In accordance with above-mentioned embodiment 6, the exchange of the session information based on the SDP is carried out with the INVITE message 200 and O.K. message 210, as previously explained. As an alternative, the exchange of the session information based on the SDP can be carried out with the O.K. message 210 and ACK message 220 without incorporating the session information based on the SDP into the INVITE message 200.

In this case, when the communication control apparatus 8 transfers the INVITE message 200e, because the ACK message 220 is transmitted directly to the VoIP terminal 4 without being passed via the communication control apparatus 8 if the Record-Route header is not added to the INVITE message 200e, the multiplexing control apparatus 9 cannot rewrite the session information based on the SDP which is included in the ACK message 220, and each of the multiplexing transmission apparatus 10 and 11 cannot multiplex voice packets.

For this reason, in the packet communication system according to above-mentioned embodiment 6, the specifications of VoIP terminals for use in the system or the communication control apparatus 8 have to be restricted.

Therefore, in accordance with embodiment 7 of the present invention, the exchange of the session information based on the SDP is carried out with the O.K. message 210 and ACK message 220, and, even when the communication control apparatus 8 does not add the Record-Route header to the INVITE message 200e, each of the multiplexing transmission apparatus 10 and 11 is enabled to multiplex voice packets.

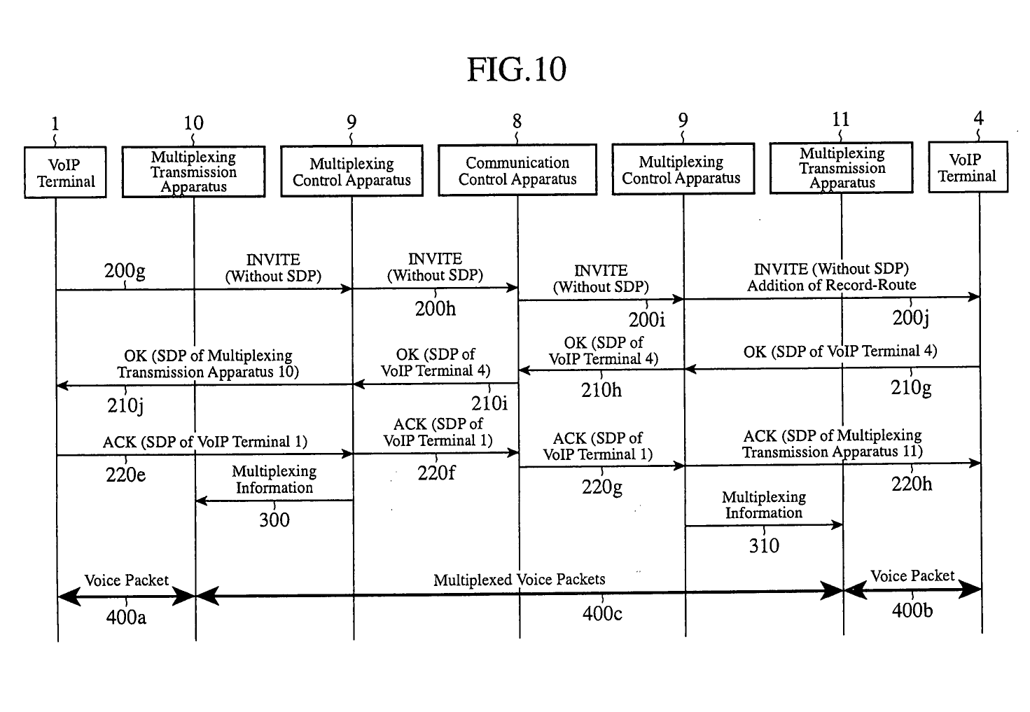

FIG. 10 is a sequence diagram showing the communications protocol of the packet communication system in accordance with embodiment 7 of the present invention.

Next, the operation of the packet communication system in accordance with this embodiment of the present invention will be explained.

First, each of the VoIP terminals 1 and 4 registers position information about itself in the communication control apparatus 8 by carrying out exchange of a REGISTER message or an O.K. message with the communication control apparatus 8. Because this registration of position information is the same as that of above-mentioned embodiment 6, the explanation of the registration will be omitted hereafter.

When the user of the VoIP terminal 1 wishes to make a telephone call with the VoIP terminal 4 and dials the telephone number of the VoIP terminal 4, the VoIP terminal 1 transmits an INVITE message 200g including the IP address of the party on the other end of the connection (i.e., the VoIP terminal 4) with which the VoIP terminal 1 desires to communicate to the communication control apparatus 8 via the local IP network 5. Because the multiplexing control apparatus 9 exists on a transmission line extending from the VoIP terminal 1 to the communication control apparatus 8, the multiplexing control apparatus 9 receives the INVITE message 200g transmitted from the VoIP terminal 1 before the communication control apparatus 8 receives the INVITE message 200g.

In this case, the session information based on the SDP is not incorporated into this INVITE message 200g.

When receiving the INVITE message 200g from the VoIP terminal 1, the multiplexing control apparatus 9 transfers the INVITE message 200g, as an INVITE message 200h, to the communication control apparatus 8.

When receiving the INVITE message 200h from the multiplexing control apparatus 9, the communication control apparatus 8 transfers the INVITE message 200h, as an INVITE message 200i, to the VoIP terminal 4. Because the multiplexing control apparatus 9 exists on a transmission line extending from the communication control apparatus 8 to the VoIP terminal 4, the multiplexing control apparatus 9 receives the INVITE message 200i transferred from the communication control apparatus 8 before the VoIP terminal 4 receives the INVITE message 200i.

When receiving the INVITE message 200i from the communication control apparatus 8, the multiplexing control apparatus 9 adds a Record-Route header indicating the IP address of the communication control apparatus 8 to the INVITE message 200i if needed.

In other words, the multiplexing control apparatus 9 analyzes the INVITE message 200i to examine whether or not the Record-Route header indicating the address of the communication control apparatus 8 is included in the INVITE message 200i, and, when the INVITE message 200i includes the Record-Route header, determines that the Record-Route header has been added to the INVITE message 200i by the communication control apparatus 8, and eliminates the process of adding the header to the INVITE message 200i, whereas when the INVITE message 200i does not include the Record-Route header, it adds the Record-Route header indicating the IP address of the communication control apparatus 8 to the INVITE message 200i.

The multiplexing control apparatus 9 transfers the INVITE message 200i including the Record-Route header, as an INVITE message 200j, to the VoIP terminal 4 via the local IP network 5, IP backbone network 7, and local IP network 6.

When receiving the INVITE message 200j from the multiplexing control apparatus 9, the VoIP terminal 4 transmits an O.K. message 210g including the IP address of the party on the other end of the connection (i.e., the VoIP terminal 1) which has desired to communicated with the VoIP terminal 4 to the communication control apparatus 8 via the local IP network 6, IP backbone network 7, and local IP network 5 in order to notify the multiplexing control apparatus 9 that the VoIP terminal 4 has received the INVITE message 200j normally. Because the multiplexing control apparatus 9 exists on the transmission line extending from the VoIP terminal 4 to the communication control apparatus 8, the multiplexing control apparatus 9 receives the O.K. message 210g transmitted from the VoIP terminal 4 before the communication control apparatus 8 receives the O.K. message 210g.

Session information based on the SDP is incorporated into this O.K. message 210g, and the IP address of the VoIP terminal 4 is described in the SDP message as the IP address of the transmission destination of voice packets transmitted from the communications partner (i.e., the VoIP terminal 1).

When receiving the O.K. message 210g from the VoIP terminal 4, the multiplexing control apparatus 9 transfers the O.K. message 210g, as an O.K. message 210h, to the communication control apparatus 8.

When receiving the O.K. message 210h from the multiplexing control apparatus 9, the communication control apparatus 8 transfers the O.K. message 210h, as an O.K. message 210i, to the VoIP terminal 1. Because the multiplexing control apparatus 9 exists on the transmission line extending from the communication control apparatus 8 to the VoIP terminal 1, the multiplexing control apparatus 9 receives the O.K. message 210i transferred from the communication control apparatus 8 before the VoIP terminal 1 receives the O.K. message 210i.

When receiving the O.K. message 210i from the communication control apparatus 8, the multiplexing control apparatus 9 rewrites the session information based on the SDP which is included in the O.K. message 210i.

In other words, because the IP address of the VoIP terminal 4 is described, as the IP address of the transmission destination of voice packets transmitted from the communications partner (i.e., the VoIP terminal 1), in the session information based on the SDP which is included in the O.K. message 210i, the multiplexing control apparatus 9 replaces the IP address of the VoIP terminal 4 with the IP address of the multiplexing transmission apparatus 10.

The multiplexing control apparatus 9 transmits the rewritten O.K. message 210i, as an O.K. message 210j, to the VoIP terminal 1 via the local IP network 5.

When receiving the O.K. message 210j from the multiplexing control apparatus 9, the VoIP terminal 1 transmits an ACK message 220e to the communication control apparatus 8 via the local IP network 5 in order to notify the multiplexing control apparatus 9 that the VoIP terminal 1 has received the O.K. message 210j normally. Because the multiplexing control apparatus 9 exists on the transmission line extending from the VoIP terminal 1 to the communication control apparatus 8, the multiplexing control apparatus 9 receives the ACK message 220e transmitted from the VoIP terminal 1 before the communication control apparatus 8 receives the ACK message 220e.

Session information based on the SDP is incorporated into this ACK message 220e, and the IP address of the VoIP terminal 1 is described in the SDP message as the IP address of the transmission destination of voice packets transmitted from the communications partner (i.e., the VoIP terminal 4).

When receiving the ACK message 220e from the VoIP terminal 1, the multiplexing control apparatus 9 transfers the ACK message 220e, as an ACK message 220f, to the communication control apparatus 8.

In this embodiment 7, in the case in which the communication control apparatus 8 does not add the Record-Route header to the INVITE message 200i, the ACK message 220 is transmitted to the VoIP terminal 4 via the communication control apparatus 8 because the multiplexing control apparatus 9 adds the Record-Route header to the INVITE message 200i.

When receiving the ACK message 220f from the multiplexing control apparatus 9, the communication control apparatus 8 transfers the ACK message 220f, as an ACK message 220g, to the VoIP terminal 4. Because the multiplexing control apparatus 9 exists on the transmission line extending from the communication control apparatus 8 to the VoIP terminal 4, the multiplexing control apparatus 9 receives the ACK message 220g transferred from the communication control apparatus 8 before the VoIP terminal 4 receives the ACK message 220g.

When receiving the ACK message 220g from the communication control apparatus 8, the multiplexing control apparatus 9 rewrites the session information based on the SDP which is included in the ACK message 220g.

In other words, because the IP address of the VoIP terminal 1 is described, as the IP address of the transmission destination of voice packets transmitted from the communications partner (i.e., the VoIP terminal 4), in the session information based on the SDP which is included in the ACK message 220g, the multiplexing control apparatus 9 replaces the IP address of the VoIP terminal 1 with the IP address of the multiplexing transmission apparatus 11.

The multiplexing control apparatus 9 transmits the rewritten ACK message 220g, as an ACK message 220h, to the VoIP terminal 4 via the local IP network 5, IP backbone network 7, and local IP network 6.

After transmitting the ACK message 220h to the VoIP terminal 4, the multiplexing control apparatus 9 transmits multiplexing information 300 to the multiplexing transmission apparatus 10 via the local IP network 5, and also transmits multiplexing information 310 to the multiplexing transmission apparatus 11 via the local IP network 5, IP backbone network 7, and local IP network 6.

The IP address of the VoIP terminal 1 which is the transmission source of IP packets, the IP address of the multiplexing transmission apparatus 11 which is the transmission destination of multiplexed IP packets, and the IP address of the VoIP terminal 4 which is the final destination are included in the multiplexing information 300 transmitted to the multiplexing transmission apparatus 10.

The IP address of the VoIP terminal 4 which is the transmission source of IP packets, the IP address of the multiplexing transmission apparatus 10 which is the transmission destination of multiplexed IP packets, and the IP address of the VoIP terminal 1 which is the final destination are included in the multiplexing information 310 transmitted to the multiplexing transmission apparatus 11.

The VoIP terminals 1 and 4 recognize the establishment of communications when the transmission of the ACK message 220 is completed in the above-mentioned way, and start transmission and reception of voice packets. After that, the packet communication system operates in the same way that that of above-mentioned embodiment 6 does. Therefore, the explanation of the operation will be omitted hereafter.

As can be seen from the above description, in accordance with this embodiment 7, the exchange of the session information based on the SDP is carried out with the O.K. message 210 and ACK message 220, and, even when the communication control apparatus 8 has not add the Record-Route header to the INVITE message, the multiplexing control apparatus 9 adds the Record-Route header to the INVITE message in place of the communication control apparatus 8 and forcedly transmits the ACK message including the SDP message via the communication control apparatus 8. As a result, in spite of whether the communication control apparatus 8 adds the Record-Route header to the INVITE message, the multiplexing control apparatus 9 can rewrite the session information based on the SDP which is included in the SIP message transmitted between the VoIP terminals 1 and 4. Therefore, the present embodiment offers an advantage of being able to reduce the overhead of IP packets without causing increase in the transmission delay of voice packets even when many VoIP terminals are connected to the local IP networks 5 and 6.

### Embodiment 8

In accordance with above-mentioned embodiment 7, in the case in which the communication control apparatus 8 does not add the Record-Route header to the INVITE message, the multiplexing control apparatus 9 adds the Record-Route header to the INVITE message in place of the communication control apparatus 8 and forcedly transmits the ACK message including the SDP message via the communication control apparatus 8, as previously explained. In this case, although the communication control apparatus 8 does not expect that it will receive the ACK message, the communication control apparatus 8 receives the ACK message from the multiplexing control apparatus 9, and therefore there is possibility that there causes an inconsistency in the internal state of the communication control apparatus 8.

Therefore, in accordance with this embodiment 8 of the present invention, the multiplexing control apparatus 9 judges whether the communication control apparatus 8 has added the Record-Route header to the INVITE message, and determines the destination of the ACK message according to the judgment result to prevent an inconsistency from being produced in the internal state of the communication control apparatus 8.

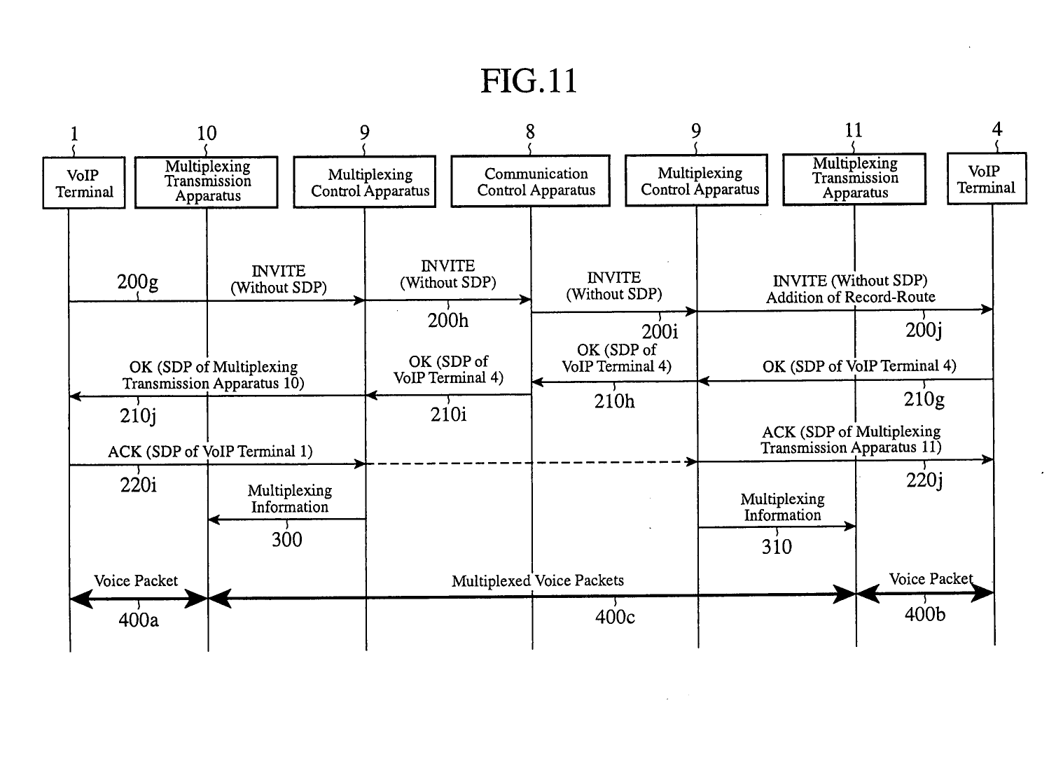

FIG. 11 is a sequence diagram showing the communications protocol of the packet communication system in accordance with embodiment 8 of the present invention.

First, each of the VoIP terminals 1 and 4 registers position information about itself in the communication control apparatus 8 by carrying out exchange of the REGISTER message or the O.K. message with the communication control apparatus 8. Because this registration of position information is the same as that of above-mentioned embodiment 6, the explanation of the registration will be omitted hereafter.

Furthermore, because the exchange of the INVITE message or the O.K. message between the VoIP terminal 1 and the VoIP terminal 4 is the same as that of above-mentioned embodiment 7, the explanation of the exchange will be omitted hereafter.

In accordance with this embodiment 8, when the communication control apparatus 8 transfers the INVITE message 200j to the VoIP terminal 4, the multiplexing control apparatus 9 records information indicating whether the communication control apparatus 8 has added the Record-Route header to the INVITE message 200j into the INVITE message 200j.

When receiving the O.K. message 210j from the multiplexing control apparatus 9, the VoIP terminal 1 transmits the ACK message 220i to the communication control apparatus 8 via the local IP network 5 in order to notify the multiplexing control apparatus 9 that the VoIP terminal 1 has received the O.K. message 210j normally.

However, when the communication control apparatus 8 has not added the Record-Route header to the INVITE message, the destination of the ACK message 220i is always the communication control apparatus 8 in spite of whether the communication control apparatus 8 has added the Record-Route header to the INVITE message because the multiplexing control apparatus 9 has added the Record-Route header to the INVITE message in place of the communication control apparatus 8.

When receiving the ACK message 220i from the VoIP terminal 1, the multiplexing control apparatus 9 refers to the information indicating whether the communication control apparatus 8 has added the Record-Route header to the INVITE message 200i, and determines the destination of the ACK message 220i.

In other words, when the multiplexing control apparatus 9 has added the Record-Route header to the INVITE message 200i, the multiplexing control apparatus 9 forcedly changes the destination of the ACK message 220i from the communication control apparatus 8 to the VoIP terminal 4, and transfers the ACK message 220i, as an ACK message 220j, to the VoIP terminal 4.

In contrast, in the case in which the multiplexing control apparatus 9 has not added the Record-Route header to the INVITE message 200i, the multiplexing control apparatus 9 does not change the destination of the ACK message 220i, but transfers the ACK message 220i to the communication control apparatus 8. In this case, the ACK message 220 is transferred by way of the same route as explained in above-mentioned embodiment 7 (i.e., via the VoIP terminal 1, multiplexing control apparatus 9, communication control apparatus 8, multiplexing control apparatus 9, and VoIP terminal 4).

When transferring the ACK message 220j to the VoIP terminal 4, the multiplexing control apparatus 9 rewrites the session information based on the SDP if it is included in the ACK message 220j.

In other words, because the IP address of the VoIP terminal 1 is described, as the IP address of the transmission destination of voice packets transmitted from the communications partner (i.e., the VoIP terminal 4), in the session information based on the SDP which is included in the ACK message 220j, the multiplexing control apparatus 9 replaces the IP address of the VoIP terminal 1 with the IP address of the multiplexing transmission apparatus 11.

After that, the packet communication system performs transmission of multiplexing information and transmission and reception of voice packets in the same way that that of above-mentioned embodiment 7 does, and therefore the explanation of them will be omitted hereafter.

As can be seen from the above description, in accordance with this embodiment 8, the multiplexing control apparatus 9 judges whether the communication control apparatus 8 has added the Record-Route header to the INVITE message and determines the destination of the ACK message according to the judgment result. Therefore the present embodiment offers an advantage of being able to prevent an inconsistency from being produced in the internal state of the communication control apparatus 8 when receiving the ACK message which it does not expect the reception, thereby increasing the reliability of the system.

### Embodiment 9

In above-mentioned embodiments 6 to 8, the multiplexing control apparatus 9 is placed on the route from the local IP network 5 to the communication control apparatus 8, and, in a case in which the destination of an SIP message transmitted from the VoIP terminal 1 or 4 is the communication control apparatus 8 (except in a case in which a direct SIP message is transmitted between the VoIP terminals), and the multiplexing control apparatus 9 relays the SIP message addressed to the communication control apparatus 8, the SIP message is rewritten if needed (e.g., session information based on the SDP is rewritten, or the Record-Route header is added to the SIP message), as previously explained. However, the present invention is not limited to this example.

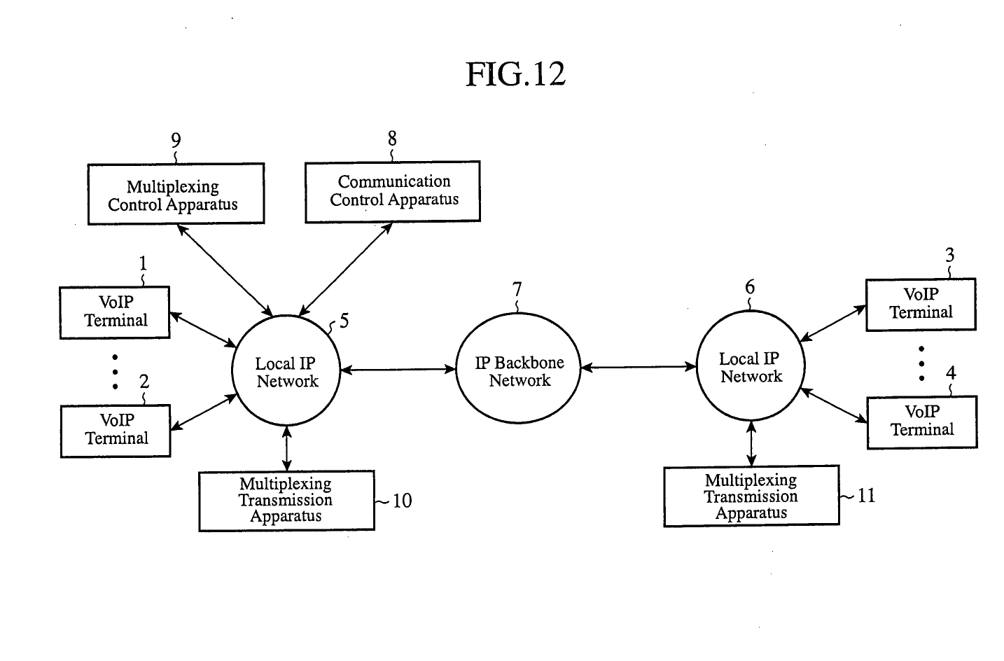

For example, as shown in FIG. 12, the multiplexing control apparatus 9 and communication control apparatus 8 are arranged so that they can be connected directly to the local IP network 5.

In this case, the destination of an SIP message transmitted from the VoIP terminal 1 or 4 is the multiplexing control apparatus 9 (except in a case in which a direct SIP message is transmitted between the VoIP terminals), and the multiplexing control apparatus 9 transfers the SIP message which it has received from the VoIP terminal 1 or 4 to the communication control apparatus 8.

An SIP message which the communication control apparatus 8 transmits to the VoIP terminal 1 or 4 is also transmitted to the multiplexing control apparatus 9 temporarily, and the multiplexing control apparatus 9 transfers it to the VoIP terminal 1 or 4.

### Embodiment 10

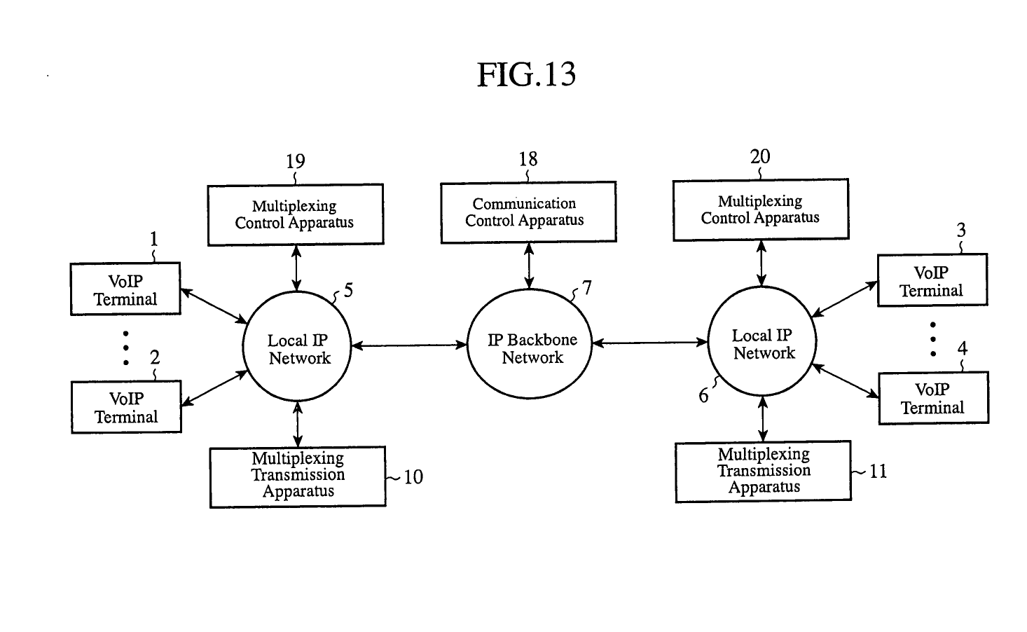

FIG. 13 is a block diagram showing a packet communication system in accordance with embodiment 10 of the present invention. In the figure, the same reference numerals as shown in FIG. 1 denote the same components or like components, and therefore the explanation of the components will be omitted hereafter.

A communication control apparatus 18 is connected to an IP backbone network 7, a multiplexing control apparatus 19 is connected to a local IP network 5, and a multiplexing control apparatus 20 is connected to a local IP network 6.

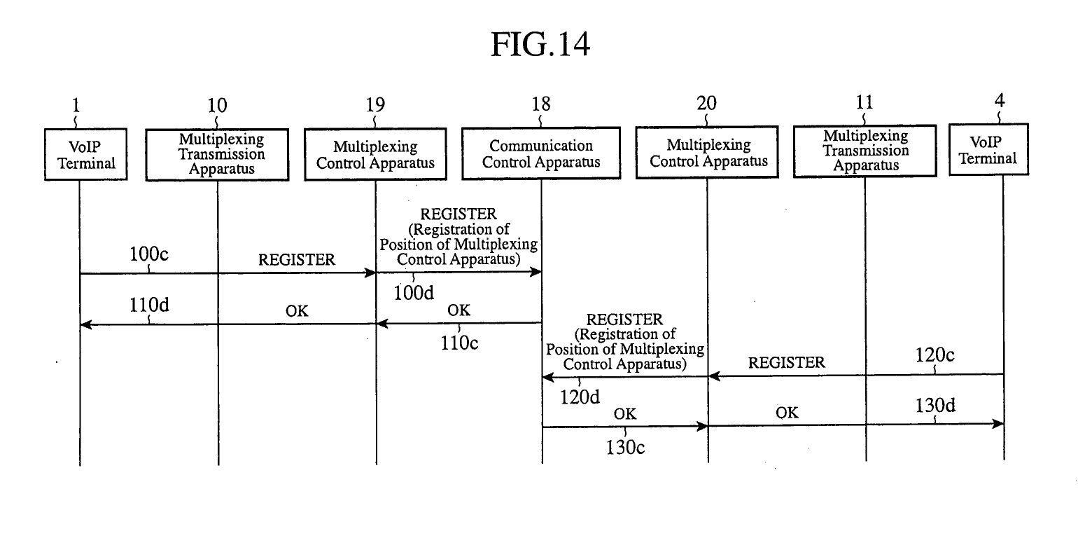

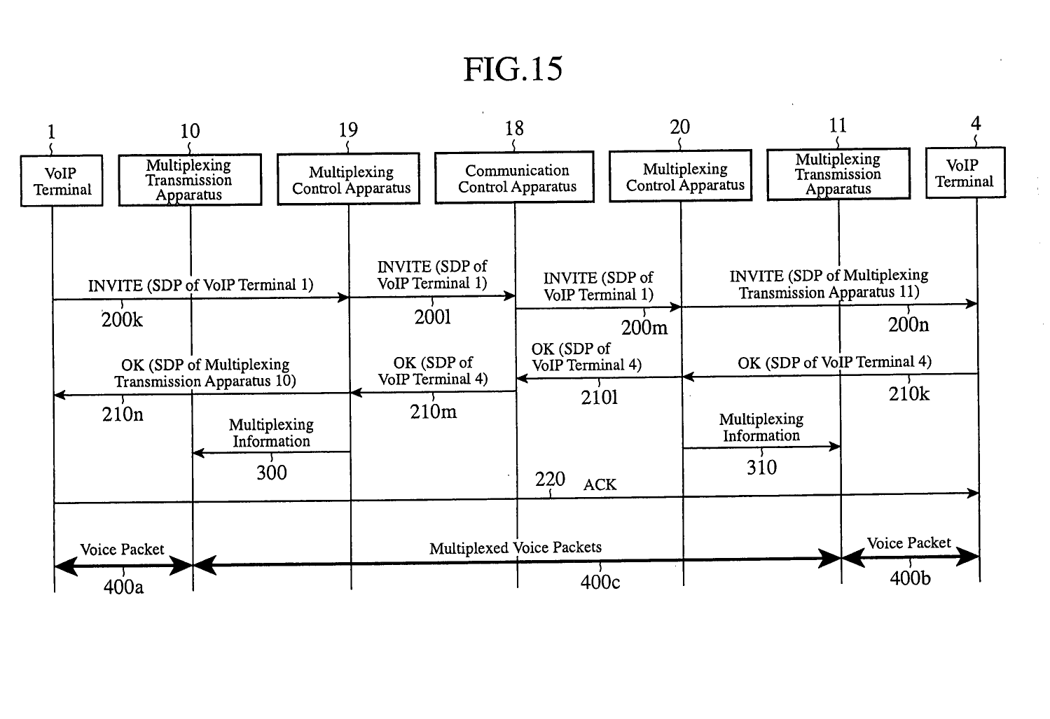

FIGS. 14 and 15 are sequence diagrams showing the communications protocol of the packet communication system in accordance with embodiment 10 of the present invention.

Next, the operation of the packet communication system in accordance with this embodiment of the present invention will be explained.

First, when the user of a VoIP terminal 1 switches on the power supply of the VoIP terminal 1, the VoIP terminal 1 transmits a REGISTER message 100c including its own IP address to the communication control apparatus 19 via the local IP network 5.

When receiving the REGISTER message 100c from the VoIP terminal 1, the multiplexing control apparatus 19 incorporates the IP address of the multiplexing control apparatus 19 into the REGISTER message 100c (or replaces the IP address of the VoIP terminal 1, which is originally included in the REGISTER message 100c, with the IP address of the multiplexing control apparatus 19), and then transfers the REGISTER message 100c, as a REGISTER message 100d, to the communication control apparatus 18 via the local IP network 5 and IP backbone network 7.

When receiving the REGISTER message 100d from the multiplexing control apparatus 19, the communication control apparatus 18 transmits an O.K. message 110c to the multiplexing control apparatus 19 via the IP backbone network 7 and local IP network 5 in order to notify the multiplexing control apparatus 19 that the communication control apparatus 18 has received the REGISTER message 100d normally.

When receiving the O.K. message 110c from the communication control apparatus 18, the multiplexing control apparatus 19 transmits the O.K. message 110c, as an O.K. message 110d, to the VoIP terminal 1 via the local IP network 5.

Similarly, when the user of a VoIP terminal 4 switches on the power supply of the VoIP terminal 4, the VoIP terminal 4 transmits a REGISTER message 120c including its own IP address to the communication control apparatus 20 via the local IP network 6.

When receiving the REGISTER message 120c from the VoIP terminal 4, the multiplexing control apparatus 20 incorporates the IP address of the multiplexing control apparatus 20 into the REGISTER message 120c (or replaces the IP address of the VoIP terminal 4, which is originally included in the REGISTER message 120c, with the IP address of the multiplexing control apparatus 20), and then transfers the REGISTER message 120c, as a REGISTER message 120d, to the communication control apparatus 18 via the local IP network 6 and IP backbone network 7.

When receiving the REGISTER message 120d from the multiplexing control apparatus 20, the communication control apparatus 18 transmits an O.K. message 130c to the multiplexing control apparatus 20 via the IP backbone network 7 and local IP network 6 in order to notify the multiplexing control apparatus 20 that the communication control apparatus 18 has received the REGISTER message 120d normally.

When receiving the O.K. message 130c from the communication control apparatus 18, the multiplexing control apparatus 20 transmits the O.K. message 130c, as an O.K. message 130d, to the VoIP terminal 4 via the local IP network 6.

The IP addresses (position information) of the multiplexing control apparatus 19 and 20 are registered into the communication control apparatus 18 through the exchange of the REGISTER message and O.K. message in the above-mentioned way.

After the registration of the pieces of position information is completed, in a case in which an SIP message is exchanged between the VoIP terminals 1 and 4, the communication control apparatus 18 can transfer the SIP message to the multiplexing control apparatus 20, not to the VoIP terminal 4, when the SIP message is transmitted by the VoIP terminal 1, and can transfer the SIP message to the multiplexing control apparatus 19, not to the VoIP terminal 1, when the SIP message is transmitted by the VoIP terminal 4.

When the user of the VoIP terminal 1 then wishes a telephone call with the VoIP terminal 4 and dials the telephone number of the VoIP terminal 4, the VoIP terminal 1 transmits an INVITE message 200k (i.e., a connection request packet) including the IP address of the party on the other end of the connection (i.e., the VoIP terminal 4) with which the VoIP terminal 1 desires to communicate to the multiplexing control apparatus 19 via the local IP network 5.

Session information based on the SDP is incorporated into this INVITE message 200k, and the IP address of the VoIP terminal 1 is described in the SDP message as the IP address of the transmission destination of voice packets transmitted from the communications partner (i.e., the VoIP terminal 4).

When receiving the INVITE message 200k from the VoIP terminal 1, the multiplexing control apparatus 19 transfers the INVITE message 200k, as an INVITE message 200l, to the communication control apparatus 18 via the local IP network 5 and IP backbone network 7.

When receiving the INVITE message 200l from the multiplexing control apparatus 19, the communication control apparatus 18 transfers the INVITE message 200l, as an INVITE message 200m, to the multiplexing control apparatus 20 via the IP backbone network 7 and local IP network 6.

In this case, a Record-Route header indicating the IP address of the communication control apparatus 8 is not added to the INVITE message 200m when the INVITE message 200m is transferred to the multiplexing control apparatus 20.

When receiving the INVITE message 200m from the communication control apparatus 18, the multiplexing control apparatus 20 rewrites the session information based on the SDP which is included in the INVITE message 200m.

In other words, because the IP address of the VoIP terminal 1 is described, as the IP address of the transmission destination of voice packets transmitted from the communications partner (i.e., the VoIP terminal 4), in the session information based on the SDP which is included in the INVITE message 200m, the multiplexing control apparatus 20 replaces the IP address of the VoIP terminal 1 with the IP address of the multiplexing transmission apparatus 11.

The multiplexing control apparatus 20 transmits the rewritten INVITE message 200m, as an INVITE message 200n, to the VoIP terminal 4 via the local IP network 6.

When receiving the INVITE message 200n from the multiplexing control apparatus 20, the VoIP terminal 4 transmits an O.K. message 210k including the IP address of the party on the other end of the connection (i.e., the VoIP terminal 1) which has desired to communicate with the VoIP terminal 4 to the multiplexing control apparatus 20 via the local IP network 6 in order to notify the multiplexing control apparatus 20 that the VoIP terminal 4 has received the INVITE message 200n normally.

Session information based on the SDP is incorporated into this O.K. message 210k, and the IP address of the VoIP terminal 4 is described in the SDP message as the IP address of the transmission destination of voice packets transmitted from the communications partner (i.e., the VoIP terminal 1).

When receiving the O.K. message 210k from the VoIP terminal 4, the multiplexing control apparatus 20 transfers the O.K. message 210k, as an O.K. message 210l, to the communication control apparatus 18 via the local IP network 6 and IP backbone network 7.

When receiving the O.K. message 210l from the multiplexing control apparatus 20, the communication control apparatus 18 transfers the O.K. message 210l, as an O.K. message 210m, to the multiplexing control apparatus 19 via the IP backbone network 7 and local IP network 5.

When receiving the O.K. message 210m from the communication control apparatus 18, the multiplexing control apparatus 19 rewrites the session information based on the SDP which is included in the O.K. message 210m.

In other words, because the IP address of the VoIP terminal 4 is described, as the IP address of the transmission destination of voice packets transmitted from the communications partner (i.e., the VoIP terminal 1), in the session information based on the SDP which is included in the O.K. message 210m, the multiplexing control apparatus 19 replaces the IP address of the VoIP terminal 4 with the IP address of the multiplexing transmission apparatus 10.

The multiplexing control apparatus 9 transmits the rewritten O.K. message 210m, as an O.K. message 210n, to the VoIP terminal 1 via the local IP network 5.

After transmitting the O.K. message 210n to the VoIP terminal 1, the multiplexing control apparatus 19 transmits multiplexing information 300 to the multiplexing transmission apparatus 10 via the local IP network 5.

The IP address of the VoIP terminal 1 which is the transmission source of IP packets, the IP address of the multiplexing transmission apparatus 11 which is the transmission destination of multiplexed IP packets, and the IP address of the VoIP terminal 4 which is the final destination are included in the multiplexing information 300 transmitted to the multiplexing transmission apparatus 10.

After transmitting the O.K. message 210l to the communication control apparatus 18, the multiplexing control apparatus 20 also transmits multiplexing information 310 to the multiplexing transmission apparatus 11 via the local IP network 6.

The IP address of the VoIP terminal 4 which is the transmission source of IP packets, the IP address of the multiplexing transmission apparatus 10 which is the transmission destination of multiplexed IP packets, and the IP address of the VoIP terminal 1 which is the final destination are included in the multiplexing information 310 transmitted to the multiplexing transmission apparatus 11.

When receiving the O.K. message 210n from the multiplexing control apparatus 19, the VoIP terminal 1 transmits an ACK message 220 to the VoIP terminal 4 in order to notify the multiplexing control apparatus 19 that the VoIP terminal 1 has received the O.K. message 210n normally.

Because the Record-Route header indicating the IP address of the communication control apparatus 18 is not added to the INVITE message 200m when the communication control apparatus 18 transfers the INVITE message 200m to the VoIP terminal 4, as mentioned above, this ACK message 220 is directly transmitted to the VoIP terminal 4 without being passed via the communication control apparatus 8.

The VoIP terminals 1 and 4 recognize the establishment of communications when the transmission of the ACK message 220 is completed in the above-mentioned way. At that time, because the multiplexing control apparatus 19 rewrites the session information based on the SDP which is included in the O.K. message 210m, the VoIP terminal 1 recognizes that the transmission destination of the voice packets is the multiplexing transmission apparatus 10, and, after that, transmits the voice packets to the multiplexing transmission apparatus 10.

When receiving the voice packets from the VoIP terminal 1, the multiplexing transmission apparatus 10 multiplexes the voice packets. In this case, when also receiving voice packets from another VoIP terminal other than the VoIP terminal 1 (e.g., the VoIP terminal 2), the multiplexing transmission apparatus 10 extracts short packets from the plurality of voice packets, collects short packets which are destined for an identical multiplexing transmission apparatus from the extracted short packets, and multiplexes and IP-packetizes the collected short packets again.

Similarly, because the multiplexing control apparatus 20 rewrites the session information based on the SDP which is included in the INVITE message 200m, the VoIP terminal 4 recognizes that the transmission destination of the voice packets is the multiplexing transmission apparatus 11, and, after that, transmits the voice packets to the multiplexing transmission apparatus 11.

When receiving the voice packets from the VoIP terminal 4, the multiplexing transmission apparatus 11 multiplexes the voice packets. In this case, when also receiving voice packets from another VoIP terminal other than the VoIP terminal 4 (e.g., the VoIP terminal 3), the multiplexing transmission apparatus 11 extracts short packets from the plurality of voice packets, collects short packets which are destined for an identical multiplexing transmission apparatus from the extracted short packets, and multiplexes and IP-packetizes the collected short packets again.

As can be seen from the above description, in accordance with this embodiment 10, each of the multiplexing control apparatus 19 and 20 rewrites session information based on the SDP which is included in an SIP message transmitted between the VoIP terminals 1 and 4 so that the transmission destination of voice packets transmitted from the VoIP terminal 1 or 4 can be recognized to be the multiplexing transmission apparatus 10 or 11. Therefore, the present embodiment offers an advantage of being able to enable the multiplexing transmission apparatus 10 and 11 to multiplex voice packets, and therefore to reduce the overhead of IP packets without causing increase in the transmission delay of voice packets even when many VoIP terminals are connected to the local IP networks 5 and 6.

### Embodiment 11

In accordance with above-mentioned embodiment 10, the exchange of the session information based on the SDP is carried out with the INVITE message 200 and O.K. message 210, as previously explained. As an alternative, the exchange of the session information based on the SDP can be carried out with the O.K. message 210 and ACK message 220 without incorporating the session information based on the SDP into the INVITE message 200.

In this case, when the communication control apparatus 18 transfers the INVITE message 200l, because the ACK message 220 is transmitted directly to the VoIP terminal 4 without being passed via the communication control apparatus 18 if the Record-Route header is not added to the INVITE message 200l, the multiplexing control apparatus 20 cannot rewrite the session information based on the SDP which is included in the ACK message 220, and each of the multiplexing transmission apparatus 10 and 11 cannot multiplex voice packets.

For this reason, in the packet communication system according to above-mentioned embodiment 10, the specifications of VoIP terminals for use in the system or the communication control apparatus 18 have to be restricted.

Therefore, in accordance with embodiment 11 of the present invention, the exchange of the session information based on the SDP is carried out with the O.K. message 210 and ACK message 220, and, even when the communication control apparatus 18 does not add the Record-Route header to the INVITE message, each of the multiplexing transmission apparatus 10 and 11 is enabled to multiplex voice packets.

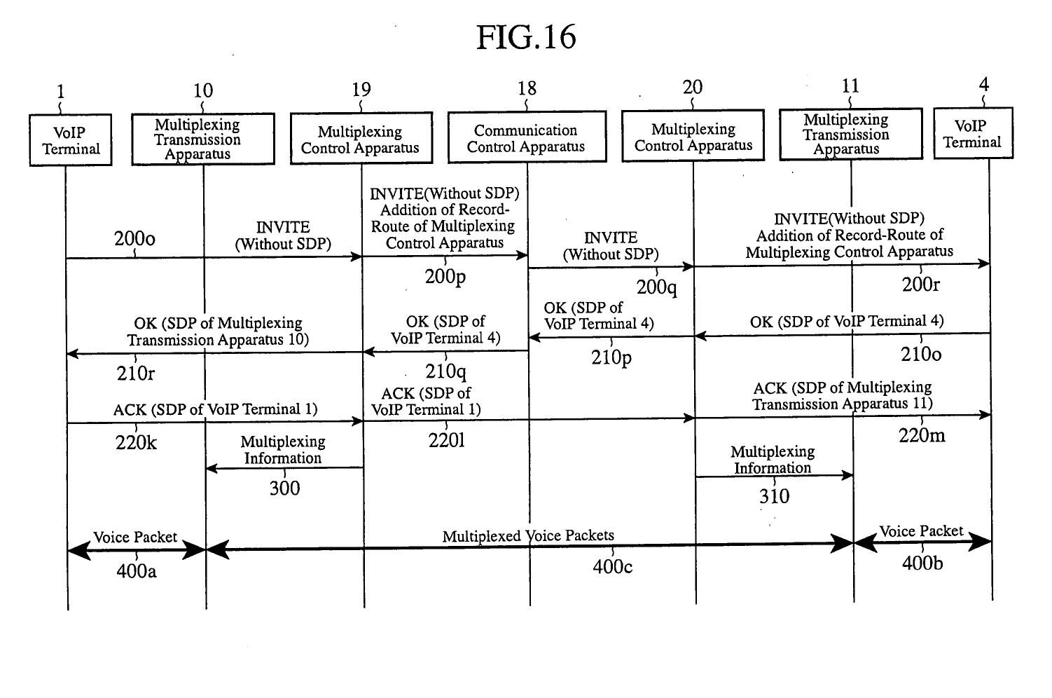

FIG. 16 is a sequence diagram showing the communications protocol of the packet communication system in accordance with embodiment 11 of the present invention.

Next, the operation of the packet communication system in accordance with this embodiment of the present invention will be explained.

When the user of the VoIP terminal 1 then wishes a telephone call with the VoIP terminal 4 and dials the telephone number of the VoIP terminal 4, the VoIP terminal 1 transmits an INVITE message 200o (i.e., a connection request packet) including the IP address of the party on the other end of the connection (i.e., the VoIP terminal 4) with which the VoIP terminal 1 desired to communicate to the multiplexing control apparatus 19 via the local IP network 5.

In this case, session information based on the SDP is not incorporated into this INVITE message 200o.

When receiving the INVITE message 200o from the VoIP terminal 1, the multiplexing control apparatus 19 adds a Record-Route header indicating the address thereof (i.e., the address of the multiplexing control apparatus 19) to the INVITE message 200o.

The multiplexing control apparatus 19 then transfers the INVITE message 200o, as an INVITE message 200p, to the communication control apparatus 18 via the local IP network 5 and IP backbone network 7.

When receiving the INVITE message 200p from the multiplexing control apparatus 19, the communication control apparatus 18 transfers the INVITE message 200p, as an INVITE message 200q, to the multiplexing control apparatus 20 via the IP backbone network 7 and local IP network 6.

In this case, when transferring the INVITE message 200q, the communication control apparatus 18 does not add a Record-Route header indicating the address of the communication control apparatus 18 to the INVITE message 200q.

When receiving the INVITE message 200q from the communication control apparatus 18, the multiplexing control apparatus 20 adds the Record-Route header indicating the address therefore (i.e., the address of the multiplexing control apparatus 20) to the INVITE message 200q.

The multiplexing control apparatus 20 then transfers the INVITE message 200q, as an INVITE message 200r, to the VoIP terminal 4 via the local IP network 6.

When receiving the INVITE message 200r from the multiplexing control apparatus 20, the VoIP terminal 4 transmits an O.K. message 210o including the IP address of the party on the other end of the connection (i.e., the VoIP terminal 1) which has desired to communicate with the VoIP terminal 4 to the multiplexing control apparatus 20 via the local IP network 6 in order to notify the multiplexing control apparatus 20 that the VoIP terminal 4 has received the INVITE message 200r normally.

Session information based on the SDP is incorporated into this O.K. message 210o, and the IP address of the VoIP terminal 4 is described in the SDP message as the IP address of the transmission destination of voice packets transmitted from the communications partner (i.e., the VoIP terminal 1).

When receiving the O.K. message 210o from the VoIP terminal 4, the multiplexing control apparatus 20 transfers the O.K. message 210o, as an O.K. message 210p, to the communication control apparatus 18 via the local IP network 6 and IP backbone network 7.

When receiving the O.K. message 210p from the multiplexing control apparatus 20, the communication control apparatus 18 transfers the O.K. message 210p, as an O.K. message 210q, to the multiplexing control apparatus 19 via the IP backbone network 7 and local IP network 5.

When receiving the O.K. message 210q from the communication control apparatus 18, the multiplexing control apparatus 19 rewrites the session information based on the SDP which is included in the O.K. message 210q.

In other words, because the IP address of the VoIP terminal 4 is described, as the IP address of the transmission destination of voice packets transmitted from the communications partner (i.e., the VoIP terminal 1), in the session information based on the SDP which is included in the O.K. message 210q, the multiplexing control apparatus 19 replaces the IP address of the VoIP terminal 4 with the IP address of the multiplexing transmission apparatus 10.

The multiplexing control apparatus 19 transmits the rewritten O.K. message 210q, as an O.K. message 210r, to the VoIP terminal 1 via the local IP network 5.

When receiving the O.K. message 210r from the multiplexing control apparatus 19, the VoIP terminal 1 transmits an ACK message 220k to the multiplexing control apparatus 19 via the local IP network 5 in order to notify the multiplexing control apparatus 19 that the VoIP terminal 1 has received the O.K. message 210r normally.

Session information based on the SDP is incorporated into this ACK message 220k, and the IP address of the VoIP terminal 1 is described in the SDP message as the IP address of the transmission destination of voice packets transmitted from the communications partner (i.e., the VoIP terminal 4).

When receiving the ACK message 220k from the VoIP terminal 4, the multiplexing control apparatus 19 transfers the ACK message 220k, as an ACK message 2201, to the multiplexing control apparatus 20 via the local IP network 5, IP backbone network 7, and local IP network 6.

In accordance with this embodiment 11, as mentioned above, the multiplexing control apparatus 19 adds the Record-Route header indicating the IP address thereof (i.e., the IP address of the multiplexing control apparatus 19) to the INVITE message 200o, and the multiplexing control apparatus 20 adds the Record-Route header indicating the IP address thereof (i.e., the IP address of the multiplexing control apparatus 20) to the INVITE message 200q. Therefore, the ACK message 220l transmitted from the multiplexing control apparatus 19 is transmitted to the multiplexing control apparatus 20 without being passed via the communication control apparatus 18.

When receiving the ACK message 220l from the multiplexing control apparatus 19, the multiplexing control apparatus 20 rewrites the session information based on the SDP which is included in the ACK message 220l.

In other words, because the IP address of the VoIP terminal 1 is described, as the IP address of the transmission destination of voice packets transmitted from the communications partner (i.e., the VoIP terminal 4), in the session information based on the SDP which is included in the ACK message 220l, the multiplexing control apparatus 20 replaces the IP address of the VoIP terminal 1 with the IP address of the multiplexing transmission apparatus 11.

The multiplexing control apparatus 20 transmits the rewritten ACK message 220l, as an ACK message 220m, to the VoIP terminal 4 via the local IP network 6.

As can be seen from the above description, in accordance with this embodiment 11, the exchange of the session information based on the SDP is carried out with the O.K. message 210 and ACK message 220, and, even when the communication control apparatus 18 does not add the Record-Route header to the INVITE message, the multiplexing control apparatus 19 or 20 adds the Record-Route header to the INVITE message in place of the communication control apparatus and forcedly transmits the ACK message including the SDP message via the multiplexing control apparatus 19 or 20. As a result, in spite of whether the communication control apparatus 18 adds the Record-Route header to the INVITE message, the multiplexing control apparatus 19 or 20 can rewrite the session information based on the SDP in the SIP message transmitted between the VoIP terminals 1 and 4. Therefore, the present embodiment offers an advantage of being able to reduce the overhead of IP packets without causing increase in the transmission delay of voice packets even when many VoIP terminals are connected to the local IP networks 5 and 6.

### Embodiment 12

In this embodiment 12, call release processing which is carried out at a time when the users of VoIP terminals finish a telephone call between them will be explained.

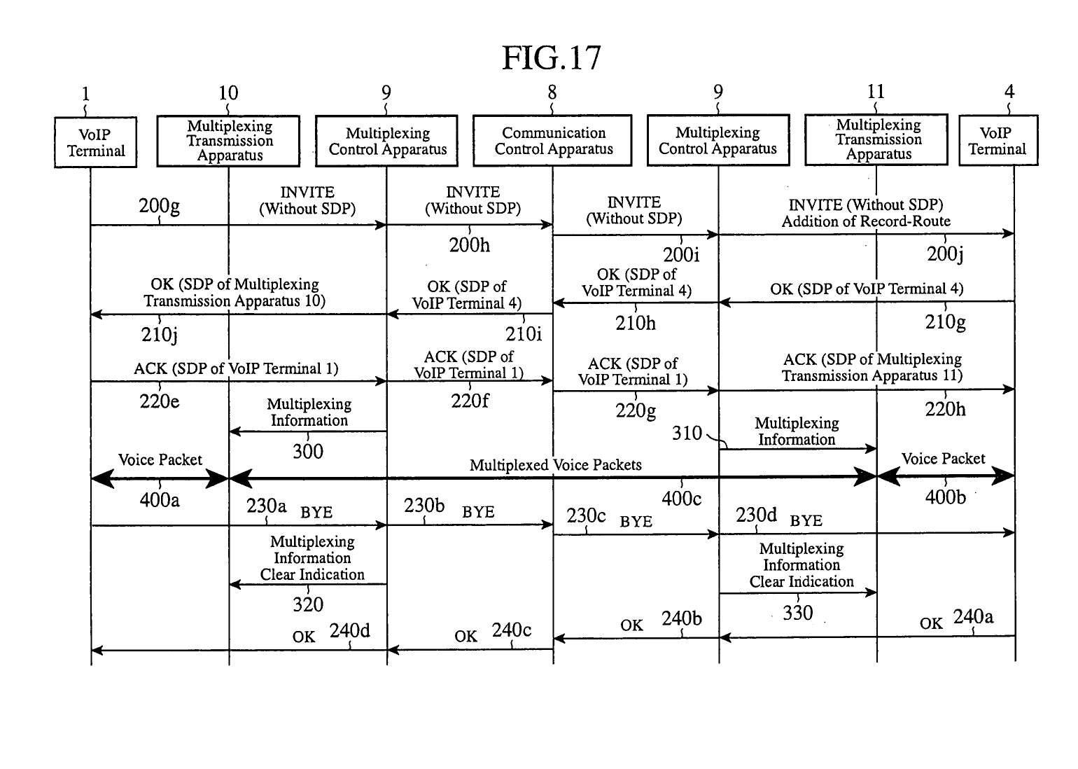

FIG. 17 is a sequence diagram showing the communications protocol of a packet communication system in accordance with embodiment 12 of the present invention.

Next, the operation of the packet communication system in accordance with this embodiment of the present invention will be explained.

Processing which is carried out until communications between VoIP terminals 1 and 4 are established and transmission and reception of voice packets is then started, by way of exchange of an SIP message, since the user of the VoIP terminal 1 has dialed the telephone number of the other VoIP terminal 4 is the same as that as explained in above-mentioned embodiment 7, the explanation of the processing will be omitted hereafter.

When the users of the VoIP terminals 1 and 4 finish a telephone call between them, and either of the caller and receiver, for example, the user of the VoIP terminal 1 makes the VoIP terminal 1 be on-hook to make the VoIP terminal 1 perform call release processing, the VoIP terminal 1 transmits a BYE message 230a to a communication control apparatus 8 via a local IP network 5. In this case, because a multiplexing control apparatus 9 exists on a transmission line extending from the VoIP terminal 1 to the communication control apparatus 8, the multiplexing control apparatus 9 receives the BYE message 230a transmitted from the VoIP terminal 1 before the communication control apparatus 8 receives the BYE message 230a.

When receiving the BYE message 230a from the VoIP terminal 1, the multiplexing control apparatus 9 transfers the BYE message 230a, as a BYE message 230b, to the communication control apparatus 8.

When receiving the BYE message 230b from the multiplexing control apparatus 9, the communication control apparatus 8 transfers the BYE message 230b, as a BYE message 230c, to the VoIP terminal 4. In this case, because the multiplexing control apparatus 9 exists on a transmission line extending from the communication control apparatus 8 to the VoIP terminal 4, the multiplexing control apparatus 9 receives the BYE message 230c transferred from the communication control apparatus 8 before the VoIP terminal 4 receives the BYE message 230c.

When receiving the BYE message 230c from the communication control apparatus 8, the multiplexing control apparatus 9 transmits the BYE message 230c, as a BYE message 230d, to the VoIP terminal 4 via the local IP network 5, an IP backbone network 7, and a local IP network 6.

When receiving the BYE message 230d from the multiplexing control apparatus 9, the VoIP terminal 4 transmits an O.K. message 240a to the communication control apparatus 8 via the local IP network 6, IP backbone network 7, and local IP network 5, in order to notify the multiplexing control apparatus 9 that the VoIP terminal 4 has received the BYE message 230d normally. In this case, because the multiplexing control apparatus 9 exists on the transmission line extending from the VoIP terminal 4 to the communication control apparatus 8, the multiplexing control apparatus 9 receives the O.K. message 240a transmitted from the VoIP terminal 4 before the communication control apparatus 8 receives the O.K. message 240a.

When receiving the O.K. message 240a from the VoIP terminal 4, the multiplexing control apparatus 9 transfers the O.K. message 240a, as an O.K. message 240b, to the communication control apparatus 8.

When receiving the O.K. message 240b from the multiplexing control apparatus 9, the communication control apparatus 8 transfers the O.K. message 240b, as an O.K. message 240c, to the VoIP terminal 1. In this case, because the multiplexing control apparatus 9 exists on the transmission line extending from the communication control apparatus 8 to the VoIP terminal 1, the multiplexing control apparatus 9 receives the O.K. message 240c transferred from the communication control apparatus 8 before the VoIP terminal 1 receives the O.K. message 240c.

When receiving the O.K. message 240c from the communication control apparatus 8, the multiplexing control apparatus 9 transmits the O.K. message 240c, as an O.K. message 240d, to the VoIP terminal 1 via the local IP network 5.

When receiving the BYE message 230a transmitted from the VoIP terminal 1 in the above-mentioned way, the multiplexing control apparatus 9 recognizes that the telephone call between the VoIP terminals 1 and 4 has been finished, transmits a multiplexing information clear indication 320 for instructing the multiplexing transmission apparatus 10 to erase previously-transmitted multiplexing information 300 to the multiplexing transmission apparatus 10 via the local IP network 5.

The multiplexing control apparatus 9 also transmits a multiplexing information clear indication 330 for instructing the multiplexing transmission apparatus 11 to erase previously-transmitted multiplexing information 310 to the multiplexing transmission apparatus 11 via the local IP network 5, IP backbone network 7, and local IP network 6.

When receiving the multiplexing information clear indication 320 from the multiplexing control apparatus 9, the multiplexing transmission apparatus 10 erases the multiplexing information 300 stored therein, i.e., the information on the IP addresses required to multiplex voice packets transmitted between the VoIP terminals 1 and 4.

When receiving the multiplexing information clear indication 330 from the multiplexing control apparatus 9, the multiplexing transmission apparatus 11 erases the multiplexing information 310 stored therein, i.e., the information on the IP addresses required to multiplex voice packets transmitted between the VoIP terminals 1 and 4.

As can be seen from the above description, in accordance with this embodiment 12, when receiving a BYE message transmitted from a VoIP terminal, each multiplexing control apparatus recognizes that a telephone call between the VoIP terminal and another VoIP terminal is finished. Therefore, the present embodiment offers an advantage of being able to detect the end of a telephone call between VoIP terminals promptly, and to erase multiplexing information.

### Embodiment 13

In accordance with above-mentioned embodiment 12, when receiving the BYE message 230a transmitted from the VoIP terminal 1, the multiplexing control apparatus 9 recognizes that a telephone call between the VoIP terminals 1 and 4 has been finished, and then transmits the multiplexing information clear indications 320 and 330 to the multiplexing transmission apparatus 10 and 11, respectively, as previously explained. As an alternative, when receiving the O.K. message 240a transmitted from the VoIP terminal 4, the multiplexing control apparatus 9 can recognize that a telephone call between the VoIP terminals 1 and 4 has been finished, and can transmit the multiplexing information clear indications 320 and 330 to the multiplexing transmission apparatus 10 and 11, respectively.

Concretely, the multiplexing control apparatus 9 operates as follows.

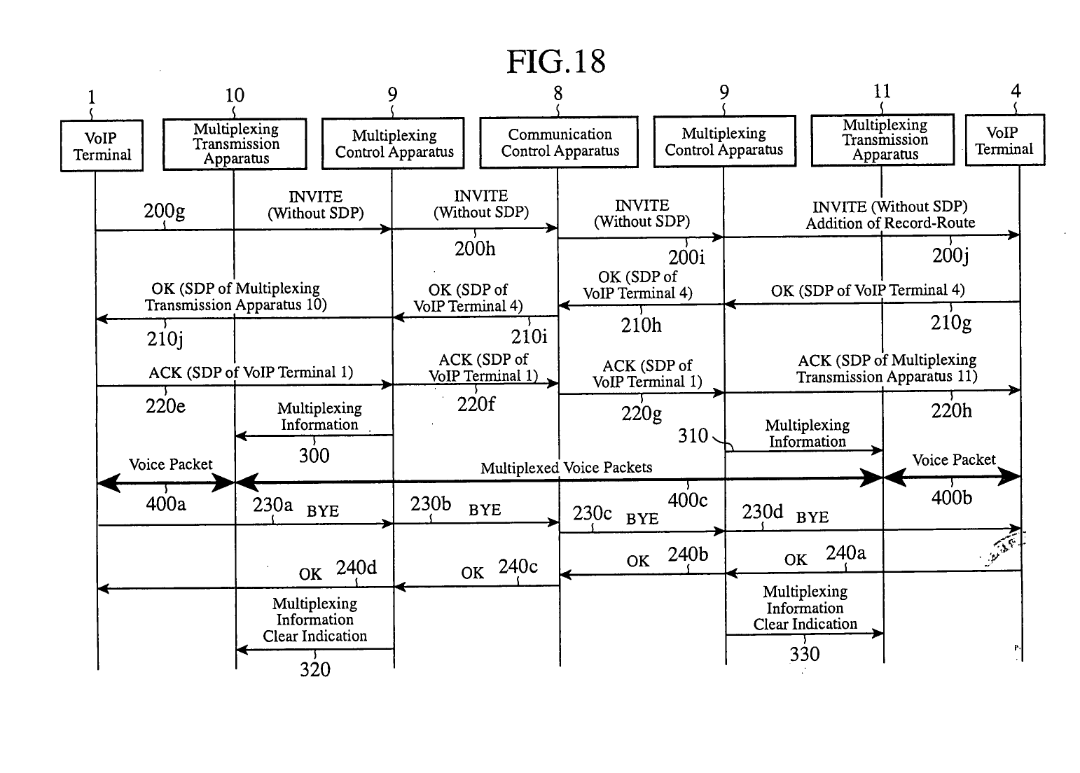

FIG. 18 is a sequence diagram showing the communications protocol of the packet communication system in accordance with embodiment 13 of the present invention.

When receiving the O.K. message 240a transmitted from the VoIP terminal 4, the multiplexing control apparatus 9 transfers the O.K. message 240a, as the O.K. message 240b, to the communication control apparatus 8, like that of above-mentioned embodiment 12.

When receiving the O.K. message 240a from the VoIP terminal 4, the multiplexing control apparatus 9 recognizes that a telephone call between the VoIP terminals 1 and 4 has been finished, and transmits a multiplexing information clear indication 320 for instructing the multiplexing transmission apparatus 10 to erase the previously-transmitted multiplexing information 300 to the multiplexing transmission apparatus 10 via the local IP network 5.

The multiplexing control apparatus 9 also transmits a multiplexing information clear indication 330 for instructing the multiplexing transmission apparatus 11 to erase the previously-transmitted multiplexing information 310 to the multiplexing transmission apparatus 11 via the local IP network 5, IP backbone network 7, and local IP network 6.

Except for this operation, the packet communication system operates in the same way that that of above-mentioned embodiment 12 does, and therefore the explanation of the other operation will be omitted hereafter.

As can be seen from the above description, in accordance with this embodiment 13, when receiving the O.K. message transmitted from a VoIP terminal as a response to a BYE message, the multiplexing control apparatus recognizes that a telephone call between the VoIP terminal and another VoIP terminal has been finished. Therefore, the present embodiment offers an advantage of being able to detect the end of a telephone call between VoIP terminals promptly, and to erase multiplexing information.

### Embodiment 14

In above-mentioned embodiments 12 and 13, when receiving a BYE message or an O.K. message transmitted from a VoIP terminal, the multiplexing control apparatus 9 recognizes that a telephone call between the VoIP terminal and another VoIP has been finished, and transmits multiplexing information clear indications 320 and 330 to the multiplexing transmission apparatus 10 and 11, respectively. The present invention is not limited to this example. As an alternative, the packet communication system can operate as follows.

The packet communication system allows the multiplexing transmission apparatus 10 and 11 to, for example, monitor whether or not voice packets are transmitted between VoIP terminals, and, when no transmission and reception of voice packets are carried out for a fixed time interval or longer, to erase the multiplexing information 300 and 310 stored therein, respectively.

As can be seen from the above description, the packet communication system in accordance with this embodiment 14 allows the multiplexing transmission apparatus 10 and 11 to monitor whether or not voice packets are transmitted between VoIP terminals, and, when no transmission and reception of voice packets are carried out for a fixed time interval or longer, to erase the multiplexing information 300 and 310 stored therein, respectively. Therefore, the packet communication system can erase the pieces of multiplexing information 300 and 310 respectively stored in the multiplexing transmission apparatus 10 and 11 without receiving the multiplexing information clear indications 320 and 330 transmitted from the multiplexing control apparatus 9. Therefore, the amount of messages between the multiplexing control apparatus 9 and the multiplexing transmission apparatus 10 and 11 can be reduced.

### INDUSTRIAL APPLICABILITY

As mentioned above, the packet communication system in accordance with the present invention is suitable for an example in which there is a necessity to reduce the overhead of IP packets without causing increase in the transmission delay of voice packets even when many VoIP terminals are connected to the network.

1. A packet communication system provided with a multiplexing transmission apparatus which, when receiving a plurality of packets from a plurality of terminal devices, multiplexing and transmitting the plurality of packets to another multiplexing transmission apparatus, and which, when receiving multiplexed packets from another multiplexing transmission apparatus, demultiplexes the multiplexed packets and transmits them to arbitrary terminal devices, said packet communication system comprising:
a communication control apparatus for, when receiving a connection request including a destination telephone number from a terminal device, searching for an address corresponding to the destination telephone number; and
a multiplexing control apparatus for identifying both a multiplexing transmission apparatus which manages a terminal device associated with the address searched for by said communication control apparatus, and a multiplexing transmission apparatus which manages the terminal device which is the transmission source of the connection request, and for notifying each of both the identified multiplexing transmission apparatus of an address of the multiplexing transmission apparatus on another end of connection and the address of the terminal device.

2. The packet communication system according to claim 1, wherein when multiplexing the plurality of packets, said multiplexing transmission apparatus forms a payload in each of the plurality of packets from a plurality of short packets, and incorporates the address of the destination terminal device into a header of each of the plurality of short packets.

3. The packet communication system according to claim 1, wherein when multiplexing the plurality of packets, said multiplexing transmission apparatus forms a payload in each of the plurality of packets from a plurality of short packets, and incorporates a serial number into a header of each of the plurality of short packets.

4. The packet communication system according to claim 1, wherein when multiplexing the plurality of packets, said multiplexing transmission apparatus forms a payload in each of the plurality of packets from a plurality of short packets, and incorporates identification information indicating a voice coding method into a header of each of the plurality of short packets.

5. The packet communication system according to claim 1, wherein in a case in which the multiplexing transmission apparatus which manages the terminal device associated with the address searched for by said communication control apparatus is the multiplexing transmission apparatus which manages the terminal device which is the transmission source of the connection request, the multiplexing control apparatus makes the terminal devices which are to communicate with each other communicate packets directly to each other without notifying any address to the multiplexing transmission apparatus.

6. The packet communication system according to claim 1, wherein when a multiplexing transmission apparatus is connected to a network, said packet communication system sets up an address of the multiplexing transmission apparatus, and addresses of terminal devices which the multiplexing transmission apparatus manages for the multiplexing control apparatus.

7. The packet communication system according to claim 6, wherein the multiplexing control apparatus provides commonality of a highmost portion of the address of the multiplexing transmission apparatus, and highmost portions of the addresses of the terminal devices.

8. The packet communication system according to claim 1, wherein in a case in which a plurality of communication control apparatus and a plurality of multiplexing control apparatus are disposed on a network, each of the plurality of communication control apparatus searches for an address of another communication control apparatus from the destination telephone number, and each of the plurality of multiplexing control apparatus identifies both a multiplexing transmission apparatus corresponding to the other communication control apparatus, and the multiplexing transmission apparatus which manages the terminal device which is the transmission source of the connection request.

9. The packet communication system according to claim 8, wherein each of the plurality of multiplexing control apparatus sets up the address of the other multiplexing control apparatus in advance.

10. The packet communication system according to claim 8, wherein when transmitting packets to the other multiplexing control apparatus, each of the plurality of multiplexing control apparatus adds addresses of multiplexing transmission apparatus which each of the plurality of multiplexing control apparatus itself manages to the packets.

11. The packet communication system according to claim 8, wherein in a case in which no multiplexing control apparatus which manages the terminal device which is the transmission destination is disposed, each of the plurality of multiplexing control apparatus transmits packets which it has received from the terminal device which is the transmission source to the terminal device which is the transmission destination without replacing the address of the terminal device which is the transmission source, the address being included in each of the packets, with an address of a multiplexing transmission apparatus which each of the plurality of multiplexing control apparatus manages.

12. The packet communication system according to claim 8, wherein in a case in which a new multiplexing control apparatus is added to the network, the new multiplexing control apparatus notifies the addition of itself to the network to each of the plurality of existing multiplexing control apparatus.

13. A packet communication system provided with a multiplexing transmission apparatus which, when receiving a plurality of packets from a plurality of terminal devices, multiplexing and transmitting the plurality of packets to another multiplexing transmission apparatus, and which, when receiving multiplexed packets from another multiplexing transmission apparatus, demultiplexes the multiplexed packets and transmits them to arbitrary terminal devices, said packet communication system comprising:
a multiplexing control apparatus for, when receiving an SIP message in which an address of a terminal device is described from the terminal device, replacing the address described in the SIP message with an address of a multiplexing transmission apparatus which manages a terminal device on another end of connection, and transmits the SIP message to the terminal device on the other end of connection.

14. The packet communication system according to claim 13, wherein when transmitting the SIP message to the terminal device, the multiplexing control apparatus adds information on a transmission route of the message to the SIP message.

15. The packet communication system according to claim 14, wherein when receiving an ACK message from the terminal device, the multiplexing control apparatus transmits it to the terminal device on the other end of communications without transmitting the ACK message to a communication control apparatus.

16. The packet communication system according to claim 13, wherein when receiving a registration message including an address of a terminal device from this terminal device, the multiplexing control apparatus replaces the address with an address thereof and transmits the registration message to a communication control apparatus.

17. The packet communication system according to claim 13, wherein when receiving a specific SIP message transmitted from a terminal device when a call is finished, the multiplexing control apparatus instructs a multiplexing transmission apparatus to erase addresses needed for communications among a plurality of terminal devices.

18. The packet communication system according to claim 13, the multiplexing control apparatus erases addresses needed for communications among a plurality of terminal devices when no packet has been transmitted from a terminal device with which the multiplexing control apparatus is communicating for a fixed time interval or longer.
